(19) United States
(12) Patent Application Publication
(10) Pub. No.: US 2012/0231430 A1
(43) Pub. Date: Sep. 13, 2012

(54) Ballet Training Method

(75) Inventor: Antonio Carlos Castillo, Kaufungen (DE)

(73) Assignees: Irina Castillo, Essen (DE); Antonio Castillo, Kaufungen (DE); Kirsten Wagner, Kassel (DE)

(21) Appl. No.: 13/045,706

(22) Filed: Mar. 11, 2011

(51) Int. Cl. G09B 19/00

(52) U.S. Cl. 434/250

(57) ABSTRACT

The process or method for teaching ballet through a series of novel floor exercise steps designed to properly condition the body of a dancer. The method warms up the muscles by performing a series of stretching protocols on a floor in a predetermined series and number of repetitions that keeps the spine, hips and shoulders in proper alignment.

### BACKGROUND OF THE INVENTION

1. The Field of the Invention

The present invention is directed generally to a process or method for training dancers, and more particularly, to a method for teaching ballet through a series of novel floor exercise steps designed to properly condition the body of a dancer.

2. Background Art

Ballet training has been relatively unchanged since the early 18^{th} Century when current teaching methods were codified. Ballet has evolved as an art form over the centuries, blending classical ballet with modern dance techniques and musical styles. To appeal to the audiences, modern choreography has grown to incorporate many expressive art forms, folk elements, acrobatics and modern dance movements, making it an art form of high complexity. This increased ballet sophistication often requires exertion exceeding a dancer's physical limit.

While floor exercise is sometimes used in modern dance and jazz classes, it is not used in the teaching of ballet. Ballet is conventionally taught with a barre. However, using a barre introduces incorrect foot positioning and weight distribution across the foot, hips and spine.

These traditional teaching methods also focus on the aesthetics of the movements and strive to achieve visually appealing movements and sequences. However, this is often at the expense of ideal anatomical orientation of the body during these dance moves. The focus of the instructor is often directed to fluidity of the sequence rather than alignment of the spine, hips and feet. Incorrect body alignment of the dancer prevents proper conditioning of the muscles and lengthens the time required to achieve a body conditioned such that it is capable of the rigors of professional dance.

Training by the conventional method requires a ballerina to concentrate simultaneously on 5 different body parts: shoulders, belly, pelvis, feet and knees. Incorrect alignment also has a second significant drawback. When the body is not optimally aligned, the brain is forced to focus its “active” attention on balance and alignment when the movements are performed in free space, lessening its attention to the details of performing the movement itself. Proper conditioning of the body creates an automatic, “second nature” or subconscious performance of a move and frees the brain to focus on external stimuli. For example, when one performs the act of walking, the directing of one foot in front of the other is at a subconscious level, freeing the brain to focus on watching for obstacles in the path rather than the literally required foot movements. In dance, proper condition of the body, also referred to as muscle learning, creates an automatic preparation for a move, permitting the brain to concentrate on only those muscles in actual observable motion and on the aesthetic quality of the move.

The study of ballet is complex and rigorous and generally requires at least eight years of constant practice to reach an advanced or professional level. Many of the moves are performed in contrast to natural human body positioning, particularly in regard to foot placement. Each human body is unique, and certain body types are more inclined to achieve the more difficult ballet moves “more” naturally. It is also well known that improper alignment during any exercise or athletic activity is often the cause of immediate or long term injury to the body. Misalignment during ballet dancing often results in knee and spinal injuries. It is always a goal to minimize the risk of injury to professional dancers and performers and to develop peak physical condition.

There exists a need for an improved method for training a ballet dancer such that the proper ballet movements can be learned and repeated more quickly and safely by any person wishing to pursue ballet.

### SUMMARY OF THE INVENTION

In accordance with the present invention, there is provided an exercise method comprising a series of exercises which is designed to accelerate the acquisition of proper ballet technique by conditioning the musculature and supporting proper posture and alignment. Briefly, the series of exercises includes stretch protocols mainly performed on the floor, and in free space as well, that aim to help the dancer to straighten the spine and general posture, distribute the weight properly across the hips, spine and feet and enable the student to learn quickly through repetition.

It is a primary object of the present invention to provide repetitive motor learning to condition the musculature such that it subconsciously (learned muscle control) performs dance movements with correct alignment, posture and weight distribution.

It is another object of the present invention to eliminate the problem of incorrect posture and to provide correct alignment of the body during each exercise.

It is another object of the present invention to eliminate the problem of incorrect weight distribution and equilibrium that is caused by use of the barre.

It is another object of the present invention to encourage abdominal breathing and promote maximum oxygen intake.

It is another object of the present invention to facilitate dancers with less natural ability to develop and properly execute dance moves.

It is another object of the present invention to reduce injury to dancers.

Whereas there may be many embodiments of the present invention, each embodiment may meet one or more of the foregoing recited objects in any combination. It is not intended that each embodiment will necessarily meet each objective. Thus, having broadly outlined the more important features of the present invention in order that the detailed description thereof may be better understood, and that the present contribution to the art may be better appreciated, there are, of course, additional features of the present invention that will be described herein and will form a part of the subject matter of this specification and claims. The present invention is capable of other embodiments and of being practiced and carried out in various ways. Also it is to be understood that the phraseology and terminology employed herein are for the purpose of description and should not be regarded as limiting.

### PARTICULAR ADVANTAGES OF THE INVENTION

The present invention provides a method for teaching ballet through a series of novel floor exercise steps designed to properly condition the body of a dancer. Repetitive motor learning through the consistent practice of this invention results in automated body alignment during any ballet posture or step, thereby permitting the brain to concentrate on only those muscles in actual observable motion and on the aesthetic quality of the move. Conditioning or muscle learning of the body to properly align during basic movements allows the alignment to be an automatic or subconscious function of the cerebellum, requiring less concentration on balance and posture and freeing the mind to focus its attention on the specific/particular movements of the body.

The goal of this method is to develop a physiological and ergonomic dance. The series of floor exercises conditions the musculature such that it subconsciously (learned muscle control) performs dance movements with correct alignment, posture and weight distribution. As a result, the ballet moves are learned more quickly and performed correctly (reducing risk of injury), even by body types that are not naturally inclined toward the postures.

Using the floor (as opposed to the barre) while performing the exercises eliminates the problem of incorrect posture and automatically provides correct alignment of the body during each exercise. For example, the knees and hips are properly aligned and the spine is straight when a dancer is lying on her back.

Using the floor during the exercises also eliminates the problem of incorrect weight distribution and equilibrium that is caused by use of the barre. It also eliminates the subconscious dependency on the barre for alignment and equilibrium while moving, which tends to create problems when moving into free space (rather than at the barre). Misalignment of the spine and hips resulting from this weight shift is eliminated when lying on the floor by isolating only those muscles necessary for movement. The floor exercises eliminate the requirement of rotating or changing sides (e.g., from left to right foot on the barre) and provide equilibrium of the body for all movements. Thus, the body is not forced to rebalance and proper posture is achieved without oblique hip extension that tends to accompany the leg on the barre.

The skills and body conditioning of the dancer are developed more quickly and easily by using muscle learning, reducing training from a period of at least eight years to a period of six years. If the student is very talented and aims to be a professional (e.g. trains at least three times, up to five times, per week on a regular basis), the learning period can be reduced further to a mere five years using the inventive “Castillo Method.” Eliminating the barre takes away any need for adjustment when transitioning from the barre to free space. Rather than depending on the barre to learn the alignment and movements, this invention trains the muscles to perform in free space in the same way.

Using the floor during the exercises encourages abdominal breathing and eliminates the problem of chest respiration that limits oxygen intake. Abdominal breathing stimulates the diaphragm, resulting in deeper breaths and, consequently, better oxygen flow, which is necessary for optimal muscle function.

In the lying position, blood pressure, circulation and heartbeat are lower. The brain has a greater supply of oxygen and is more receptive to proper conditioning of the muscles. Increased oxygen supply allows for more attention to the exercise steps, which is necessary for motor learning.

The risk of injury from a hollow back and kidney damage is reduced because in the lying position, the floor prohibits the student from sticking out the pelvis during movements like a grand plié or a passé. All the inner organs (peripheries) will stay in their regular places. In the lying position, the entire length of the back maintains contact with the floor, thereby training the muscles to retain this posture during movement of other parts of the body. Over time, performing out of alignment contributes to joint and bone problems like arthritis and scoliosis. By creating subconsciously automated alignment through muscle memory, these risks are reduced.

This method allows dancers with less natural ability to develop and properly execute dance moves.

### BRIEF DESCRIPTION OF THE DRAWINGS

In order that the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 depicts a student sitting on a floor with the spine straight and the legs extended forward, the feet pointed in first position, the arms straight at each respective side and the hands on the floor facing outwardly in a relaxed manner such that the body weight is not born on the hands.

FIG. 2 depicts a student sitting on a floor with the spine straight and the legs extended forward, the arms straight at each respective side, the hands on the floor facing outwardly and the feet flexed in a first position.

FIG. 3 depicts a student sitting on a floor with the spine straight, arms straight at each respective side, the legs bent into a demi-plié position and the feet flexed in a first position.

FIG. 4 depicts a student with the feet pointed in first position, arms straight at each respective side, hands on the floor facing outwardly, the hips and legs raised off the floor.

FIG. 5 depicts a student sitting on a floor with the spine straight and the legs extended outwardly and spread wide apart (“écarté”), the feet pointed in a second position, the arms straight at each respective side and the hands on the floor facing outwardly in a relaxed manner such that the body weight is not born on the hands.

FIG. 6 depicts a student sitting on a floor with the spine straight and the legs extended outwardly and spread wide apart, the feet flexed and the arms straight at each respective side with the hands on the floor facing outwardly in a relaxed manner such that the body weight is not born on the hands.

FIG. 7 depicts a student sitting on a floor with the spine straight, arms straight at each respective side with the hands on the floor facing outwardly in a relaxed manner such that the body weight is not born on the hands, the legs in écarté and bent into a demi-plié position and the feet flexed in second position.

FIG. 8 depicts a student with the spine straight, arms straight at each respective side, the hands on the floor and facing outwardly, the legs separated in écarté and the hips lifted from the floor such that the body weight is born on the hands and the heels of the feet, which remain pointed in second position.

FIG. 9 depicts a student sitting on the floor, the spine straight, the arms straight at each respective side in a relaxed manner such that weight is not born on the hands, the hands on the floor and facing outwardly, the right leg extended straight forward, the right foot pointed, the left leg lifted, and the left foot is flexed in first position en dehors.

FIG. 10 depicts a student sitting on the floor, the spine straight, the arms straight at each respective side in a relaxed manner such that weight is not born on the hands, the hands on the floor and facing outwardly, the right leg extended straight forward, the left leg extended to the left side and the feet pointed.

FIG. 11 depicts a student sitting on the floor, the spine straight, the arms straight at each respective side in a relaxed manner such that weight is not born on the hands, the hands on the floor and facing outwardly, the right leg extended straight forward, the right foot pointed, the left leg bent at the knee, the left knee raised slightly, the bottom of the left foot touching the inside of the right ankle and the feet pointed.

FIG. 12 depicts a student sitting on the floor, the spine straight, the arms straight at each respective side in a relaxed manner such that weight is not born on the hands, the hands on the floor and facing outwardly, the right leg extended straight forward, the left leg bent at the knee, the left knee raised slightly, the bottom of the left foot touching the inside of the right knee and the feet pointed.

FIG. 13 depicts a student sitting on the floor, the spine straight, the arms straight at each respective side in a relaxed manner such that weight is not born on the hands, the hands on the floor and facing outwardly, the right leg extended straight forward, the right foot pointed, the left leg bent at the knee, the left knee raised such that the left leg faces forward, the left foot pointed and the left heel raised off the floor.

FIG. 14 depicts a student lying on the stomach on the floor with the right and left legs extended straight behind, the feet pointed, the arms crossed in front and the forehead or chin resting on the hands such that the torso is lifted slightly but the chest is still touching the floor.

FIG. 15 depicts a student lying on the stomach on the floor with the right and left legs extended straight behind, the right foot pointed, the left leg raised about 20 degrees off the floor, the left foot flexed, the arms crossed in front and the forehead or chin resting on the hands such that the torso is lifted slightly but the chest is still touching the floor.

FIG. 16 depicts a student lying on the stomach on the floor with the right leg extended straight behind, the right foot pointed, the left leg extended to the left about 45 degrees with respect to the right leg, the left foot is flexed and turned outwardly such that the inside of the left leg is pressing into the floor, the arms crossed in front and the forehead or chin resting on the hands such that the torso is lifted slightly but the chest is still touching the floor.

FIG. 17 depicts a student lying on the stomach on the floor with the right and left legs extended straight behind, the feet pointed, the arms in a second position with the hands pointed outwardly, the arms bent and the forehead facing forward.

FIG. 18 depicts a student lying on the stomach on the floor with the right and left legs extended straight behind, the feet pointed, the arms in a second position with the hands pointed outwardly, the arms extended straight such that the torso is lifted off the floor and the forehead facing forward.

FIG. 19 depicts a student sitting on a floor with the spine straight, arms straight at each respective side in a relaxed manner such that weight is not born on the hands, the hands on the floor facing outwardly, the right leg extended forward and the right foot pointed, the left foot flexed and lifted up to an angle of not more than 5 degrees with respect to the floor, the left heel above the right ankle and the left knee bent outwardly.

FIG. 20 depicts a student sitting on a floor with the spine straight, arms straight at each respective side in a relaxed manner such that weight is not born on the hands, the hands on the floor facing outwardly, the right leg extended forward and the right foot pointed, the left leg extended fully and lifted, the left foot pointed.

FIG. 21 depicts a student sitting on a floor with the spine straight, arms straight at each respective side in a relaxed manner such that weight is not born on the hands, the hands on the floor facing outwardly, the right leg extended forward and the right foot pointed, the left leg lifted and extended straight and to the left about 20 degrees with respect to the right leg, the left foot pointed.

FIG. 22 depicts a student sitting on a floor with the spine straight, arms straight at each respective side in a relaxed manner such that weight is not born on the hands, the hands on the floor facing outwardly, the legs bent into a demi-plié position with the left ankle resting above the right ankle.

FIG. 23 depicts a student with legs in the demi-plié position, the left ankle resting on the right ankle, the hands on the floor facing outwardly, the arms straight, the hips and legs raised off the floor.

FIG. 24 depicts a student with hands on floor facing outwardly, arms straight, hips and legs raised off the floor, the right leg in a demi-plié position, the left leg extended straight and raised off the floor, the left foot pointed.

FIG. 25 depicts a student lying on the back on the floor, legs extended straight forward, feet pointed in first position, the arms on the floor in second position.

FIG. 26 depicts a student lying on the back on the floor, arms in second position, the right leg bent into passé position en dehors with the right foot flexed, and the left leg extended straight with the left foot pointed.

FIG. 27 depicts a student lying on the back on the floor, arms in second position, the right leg bent into passé position en dehors with the right foot flexed, and the left leg extended straight and lifted with the left foot flexed.

FIG. 28 depicts a student lying on the back on the floor, arms in second position, the right leg bent into passé position en dehors with the right foot flexed, and the left leg raised off the floor, extended straight and to the left with the left foot pointed.

FIG. 29 depicts a student lying on the stomach on the floor, the right leg extended straight back, the right foot pointed, the left leg straight and extended at a 25-degree angle with respect to the right leg, the left foot flexed and internally rotated such that the inside of the left foot is pressed into the floor, the arms in second position with the hands facing outwardly and the arms bent.

FIG. 30 depicts a student with arms in second position and with the hands on the floor facing outwardly, the arms straight, the right leg extended straight back and the right foot pointed, the left leg straight and extended at a 25-degree angle with respect to the right leg, the left foot flexed and internally rotated such that the inside of the left foot is pressed into the floor, the hips and legs raised off the floor such that the head to the feet form a substantially straight line.

FIG. 31 depicts a student as if sitting on the floor, but with the hips raised off the floor, the body weight supported by the hands and heels of the feet, the hands on the floor at each respective side facing outwardly, the arms are straight, the legs are extended straight and spread wide apart, the feet are pointed in first position.

FIG. 32 depicts a student sitting on the floor with the spine straight and the legs extended outwardly and spread wide apart (“écarté”), the feet pointed in a second position, the arms in a second position.

FIG. 33 depicts a student sitting on a floor with the spine straight and the legs extended outwardly and spread wide apart (“écarté”), the feet pointed in a second position, the arms in a fifth position.

FIG. 34 depicts a student as if sitting on the floor, but with the hips raised off the floor, the body weight shifted slightly forward and supported by the hands and heels of the feet, the hands are on the floor in front of the torso, one hand stacked on the other, the arms are straight, the legs are extended straight and spread wide apart (“écarté”), the feet are pointed in second position.

FIG. 35 depicts a student sitting on the floor such that the spine is straight, the arms in a second position, the legs are spread wide apart with the right leg extended and the right foot pointed, the left leg bent into a demi-plié position and the left foot flexed.

FIG. 36 depicts a student sitting on the floor such that the spine is straight, the legs are spread wide apart with the right leg extended straight and the right foot pointed, the left leg bent into a demi-plié position and the left foot flexed, the left arm lifted into a first position and the right arm lifted into a fifth position.

FIG. 37 depicts a student sitting on the floor, the legs are spread wide apart with the right leg extended straight and the right foot pointed, the left leg bent into a demi-plié position and the left foot flexed, the left arm lifted into a first position and the right arm lifted into a fifth position, the torso bent to the left from the hip towards the left knee.

FIG. 38 depicts a student sitting on the floor, the legs are spread wide apart with the right leg extended straight and the right foot pointed, the left leg bent into a demi-plié position and the left foot flexed, the torso bent to the left from the hip towards the left knee, the arms in a second position.

FIG. 39 depicts a student lying on the back on the floor such that the spine is straight and the legs are extended, the feet pointed in first position, the arms in second position and the palms of the hands facing the floor.

FIG. 40 depicts a student lying on the back on the floor such that the spine is straight and the arms are in second position with the palms of the hands facing the floor, the left leg bent at the knee such that the left knee is at a 45-degree angle with respect to the right leg, which is extended straight forward, both feet pointed.

FIG. 41 depicts a student lying on the back on the floor such that the spine is straight and the arms are in second position with the palms of the hands facing the floor, the legs extended straight and the feet pointed, the left leg lifted vertically off the floor.

FIG. 42 depicts a student lying on the back on the floor such that the spine is straight and the arms are in second position with the palms of the hands facing the floor, the legs bent into a grand plié position.

FIG. 43 depicts a student lying on the back on the floor such that the spine is straight and the arms are in second position with the palms of the hands facing the floor, the legs extended straight forward and lifted about 45 degrees off the floor.

FIG. 44 depicts a student lying on the back on the floor such that the spine is straight and the arms are in second position with the palms of the hands facing the floor, the legs extended straight and lifted off the floor about 90 degrees with respect to the torso.

FIG. 45 depicts a student lying on the back on the floor, the legs bent into a grand plie position, the hips lifted off the floor and the arms in first position.

FIG. 45a depicts a student with arms in first position.

FIG. 46 depicts a student lying on the back on the floor such that the spine is straight, the arms are in second position, the right leg is extended straight, the right foot pointed, the left leg extended straight and lifted off the floor, the left foot flexed.

FIG. 47 depicts a student sitting on the floor such that the spine is straight, the legs are bent, the feet are pointed, the bottoms of the feet facing inward and the toes touching, the left hand grasping the left heel and the right hand grasping the right heel such that the arms are extended straight and the inside of the elbows are facing out.

FIG. 48 depicts a student sitting on the floor such that the spine is straight, the left hand grasping the left heel and the right hand grasping the right heel such that the arms are extended straight and the inside of elbows are facing out, the right leg bent and the right foot pointed, the left leg extended straight and lifted about 45 degrees with respect to the torso.

FIG. 49 depicts a student sitting on the floor such that the spine is straight, the left hand grasping the left heel and the right hand grasping the right heel such that the arms are extended straight and the inside of elbows are facing out, the legs extended straight, spread wide apart from each other and lifted about 45 degrees with respect to the torso.

FIG. 50 depicts a student lying on the back on the floor with the spine straight and the legs extended forward, the feet pointed in first position, the arms curved at each respective side with the palms of the hands on the floor facing inwardly toward the body.

FIG. 51 depicts a student lying on the back on the floor with the spine straight and the legs extended forward, the feet flexed in first position.

FIG. 52 depicts a student lying on the back on the floor with the spine straight and the arms in first position.

FIG. 53 depicts a student lying on the back on the floor with the spine straight and the arms in second position.

FIG. 54 depicts a student lying on the back on the floor with the spine straight and the legs bent in a demi-plié position and the feet flexed in first position.

FIG. 55 depicts a student as if lying on the back on the floor with the spine straight and the legs extended forward, the feet pointed in first position, but with the hips raised vertically off the floor such that the weight is supported on the shoulders and feet and the arms extended on the floor at each respective side.

FIG. 56 depicts a student lying on the back on the floor with the spine straight and the legs extended forward and spread wide apart from one another, the feet pointed in second position, the arms curved at each respective side with the palms of the hands facing inwardly towards the body.

FIG. 57 depicts a student lying on the back on the floor with the spine straight and the legs extended forward and spread wide apart from one another, the feet flexed in second position.

FIG. 58 depicts a student lying on the back on the floor with the spine straight and the legs spread wide apart from one another and bent in a demi-plié position, the feet flexed.

FIG. 59 depicts a student lying on the back on the floor with the spine straight and the legs extended forward and spread wide apart from one another, the feet pointed in second position, with the hips raised vertically off the floor such that the weight is supported on the shoulders and feet and the arms are extended on the floor at each respective side.

FIG. 60 depicts a student lying on the back on the floor with the spine straight and the right leg extended forward, the right foot pointed in first position, the left foot flexed and the left leg lifted vertically from the floor at about a 20-degree angle with respect to the floor, the right arm in first position and the left arm in second position.

FIG. 61 depicts a student lying on the back on the floor with the spine straight and the right leg extended forward, the right foot pointed in first position, the left foot flexed and the left leg extended to the left at about a 45-degree angle with respect to the right leg, the right arm in second position and the left arm in first position.

FIG. 62 depicts a student lying on the floor on the right side of the body such that the right arm is extended straight, the head resting on the right arm, the left hand resting on the floor in front of the torso, the left hip and left leg stacked on the right hip and right leg and the feet pointed in first position.

FIG. 63 depicts a student lying on the floor on the right side of the body such that the right arm is extended straight, the head resting on the right arm, the left hand resting on the floor in front of the torso, the left leg bent slightly so that the left foot touches the inside of the right heel and the feet pointed.

FIG. 64 depicts a student lying on the floor on the right side of the body such that the right arm is extended straight, the head resting on the right arm, the left hand resting on the floor in front of the torso, the left leg bent with the left knee extended outwardly and the left foot resting at the hollow of the right knee.

FIG. 65 depicts a student lying on the back on the floor such that the spine is straight and the right leg is extended, the right foot pointed in first position, the left leg lifted up to an angle of not more than 5 degrees with respect to the floor such that the left heel (left foot flexed) is above the right ankle and the left knee is bent outwardly.

FIG. 66 depicts a student lying on the back on the floor, the left arm on the floor and curved slightly, the right arm in second position.

FIG. 67 depicts a student lying on the back on the floor such that the spine is straight and the right leg is extended, the right foot pointed in first position, the left leg extended and lifted up to an angle of not more than 5 degrees with respect to the floor, the left foot pointed, the left arm on the floor and curved slightly, the right arm in second position.

FIG. 68 depicts a student on the floor, with the back of the torso facing the floor, the right leg bent into a demi-plié position with the right foot flexed, the left foot flexed and resting above the right ankle, the hips raised vertically off the floor such that the body weight is supported in the shoulders and the right foot.

FIG. 69 depicts a student on the floor, with the back of the torso facing the floor, the right leg bent into a demi-plié position with the right foot flexed, the left leg extended out to the left side, the left foot pointed, the hips raised vertically off the floor such that the body weight is supported in the tops of the shoulders and the right foot.

FIG. 70 depicts a student with the front of the torso facing the floor, the hands on the floor facing outwardly, the legs extended straight back with the feet pointed, the body raised off the floor such that the body weight is supported on the hands and the tops of the feet.

FIG. 71 depicts a student with the front of the torso facing the floor, the hands on the floor facing outwardly, the right leg extended straight back with the right foot pointed, the body raised off the floor such that the body weight is supported on the hands and the top of the right foot, the left foot flexed and the inside of the left ankle resting above the bottom of the right heel.

FIG. 72 depicts a student with the front of the torso facing the floor, the hands on the floor facing outwardly, the right leg extended straight back with the right foot pointed, the body raised off the floor such that the body weight is supported on the hands and the top of the right foot, the left leg extended straight and behind the body, the left foot pointed.

FIG. 73 depicts a student with the front of the torso facing the floor, the hands on the floor facing outwardly, the right leg extended straight back with the right foot pointed, the body raised off the floor such that the body weight is supported on the hands and the top of the right foot, the left leg extended straight and to the left side, the left foot pointed.

FIG. 74 depicts a student lying on the back on the floor such that the spine is straight and the left leg is extended, the left foot pointed in first position, the right leg bent into a passé position, the arms in second position.

FIG. 75 depicts a student lying on the back on the floor such that the spine is straight, the right leg bent into a passé position, the left foot flexed, the left leg extended straight and raised vertically to about 90 degrees with respect to the torso, the left arm in second position and the right arm in first position.

FIG. 76 depicts a student lying on the back on the floor such that the spine is straight, the right leg bent into a passé position, the left foot flexed, the left leg extended straight and to the left side until it is about 5 degrees off the floor and the arms in second position.

FIG. 77 depicts a student lying on the stomach on the floor, the right leg extended straight back with the right foot pointed, the left leg extended to the left side with the left foot pointed, the hands on the floor next to the shoulder and facing outwardly and the forehead facing forward.

FIG. 78 depicts a student with hands on the floor facing outwardly, the right leg extended straight back with the right foot pointed, the left leg extended to the left side with the left foot pointed, the body raised off the floor such that the body weight is supported on the hands and the tops of the feet.

FIG. 79 depicts a student sitting on the floor such that the spine is straight and the legs are extended forward and spread wide apart from one another, the feet are pointed, the left arm in first position and the right arm in fifth position.

FIG. 80 depicts a student sitting on the floor such that the spine is straight and the legs are extended forward and spread wide apart from one another, the feet are pointed, the torso bent to the left from the hip, the left arm in first position and the right arm extended straight and parallel to the left leg.

FIG. 81 depicts a student lying on the floor on the back such that the spine is straight and the right leg is extended, the right foot pointed, the left leg bent with the left foot angled at the hollow of the knee such that the left knee is at a 45-degree angle with respect to the right leg, the left arm resting at the left side of the body and the right arm in first position.

FIG. 82 depicts a student lying on the floor on the right side of the body such that the right arm is extended straight above, the head resting on the right arm, the left hand resting on the floor in front of the torso, the left leg extended straight and raised vertically to about 90 degrees with respect to the torso.

FIG. 83 depicts a student lying on the back on the floor such that the spine is straight, the legs bent into a grand plié position and the arms in first position.

FIG. 84 depicts a student lying on the floor on the back such that the spine is straight, the legs extended straight and raised vertically to about 90 degrees with respect to the torso, the feet pointed in first position and the arms in first position.

FIG. 85 depicts a student lying on the floor on the back such that the spine is straight and the right leg is extended forward, the right foot pointed, the left foot flexed, the left leg raised to about a 90-degree angle with respect to the torso, the arms in second position.

FIG. 86 depicts a student lying on the floor on the right side of the body such that the right arm is extended straight above, the head resting on the right arm, the left hand resting on the floor in front of the torso, the left foot flexed and the left leg lifted to about a 90-degree angle with respect to the torso.

### PARTS LIST

2—student
4—floor
6—spine (back)
8—right leg and left leg collectively
8a—right leg
8b—left leg
10—right foot and left foot collectively
10a—right foot
10b—left foot
12—right arm and left arm collectively
12a—right arm
12b—left arm
14—right hand and left hand collectively
14a—right hand
14b—left hand
16—right knee and left knee collectively
16a—right knee
16b—left knee
18—right hip and left hip collectively
18a—right hip
18b—left hip
20—straight line
21—100-degree angle
22—left and right shoulders collectively
22a—right shoulder
22b—left shoulder
24—heel of right foot and heel of left foot collectively
24a—heel of right foot
24b—heel of left foot
25—body
26—20-degree angle
28—45-degree angle
30—ankle of right foot and ankle of left foot collectively
30a—ankle of right foot
30b—ankle of left foot
32—toes of right foot and toes of left foot collectively
32a—toes of right foot
32b—toes of left foot
34—stomach
36—chin
37—head
38—forehead
40—torso
42—chest
43—head
44—20-degree angle
46—45-degree angle
48—straight line
50—5-degree angle
52—20-degree angle
53—20-degree angle
54—5-degree angle
56—45-degree angle
58—20-degree angle
59—25-degree angle
60—straight line
62—fingers of the right and left hand collectively
64—45-degree angle
66—60-degree to 90-degree angle
68—pelvis
70—45-degree angle
72—90-degree angle
73—90-degree angle
74—elbows of the right and left arms collectively
74a—elbow of the right arm
74b—elbow of the left arm
76—45-degree angle

### DEFINITIONS OF TERMS USED IN THIS SPECIFICATION

As used in this specification, the term “barre” (also known as “bar”) shall mean the railing, about waist high, along the wall of a studio that is used by dancers to steady themselves in the first part of a class.

There are three basic positions of the arms described below:
First position: arms are curved inward and brought up so that the tips of the fingers are in line with the navel.
Second position: arms are out to the sides, angled down and forward, with palms facing forward. Elbows are slightly lower than the shoulders.
Fifth position: both arms are rounded and held above and slightly forward of the head.
   There are two basic positions of the feet described below:
First position: feet are aligned outwardly with heels and knees touching.
Second position: feet in line, heels apart (separated by about the length of one's foot).

As used in this specification, the term “battement” shall mean a movement of a leg in which the leg is extended and then returned.

As used in this specification, the term “battement developpé” shall mean raising a leg in any direction, with the knee of that leg sharply bent so that the toes are pointed next to the opposite knee, and then the raised leg is fully extended.

As used in this specification, the term “battement frappé” shall mean moving the foot from a flexed position next to the opposite ankle and extending it to a straight position in any given direction.

As used in this specification, the term “battement jeté” shall mean lifting a fully-extended leg about 20 degrees with respect to the opposite leg.

As used in this specification, the term “battement tendu” shall mean sliding a foot out until the leg is fully extended and the toes are pointed, then sliding the foot back to the starting position without the foot or toe loosing contact with the floor.

As used in this specification, the term “cambré” shall mean a bend from the waist in any direction, but especially forward or back.

As used in this specification, the term “cou-de-pied” shall mean the thinnest part of the calf, just above the ankle.

As used in this specification, the term “sur le cou-de-pied” shall mean placing the foot on the calf just above the ankle.

As used in this specification, the term “demi rond de jambe” shall mean lifting a fully-extended leg, then moving the leg in a half circle, such that the entire movement forms the letter D′.

As used in this specification, the term “demi-plié” shall mean a smooth and continuous bending of the knees until the knees are just below the hips while maintaining turn-out at the joints, allowing the thighs and knees to be directly above the line of the toes without lifting the heels off the floor.

As used in this specification, the term “demi plié in écarté” shall mean performing a demi-plié with the legs and feet spread apart from one another.

As used in this specification, the term “Demi-plié with frappe” shall mean a movement in the demi-plié position, in which a foot moves from a flexed position on to the opposite ankle, and extends such that the leg is straight and the toes are pointed, and then returns to the starting position.

As used in this specification, the term “developpé” shall mean a movement in which a leg bends and the foot draws up the opposite leg to the opposite knee, and from there extends smoothly out, usually at 90 degrees with respect to the opposite leg.

As used in this specification, the term “écarté” shall mean that the legs are separated from each other.

As used in this specification, the term “en dehors” shall mean any motion away from the front of the body.

As used in this specification, the term “extension” shall mean a straightening of the arm or leg.

As used in this specification, the term “flex” shall mean raising the toes of the foot such that the foot is perpendicular to the leg.

As used in this specification, the term “grand battement” shall mean raising a fully-extended leg quickly while keeping the rest of the body still, and returning the leg slowly to the starting position.

As used in this specification, the term “Grand plié” shall mean a smooth, continuous, and complete bending of the knees until the knees are over the feet and the heels are off the floor, while maintaining a straight back and full turn-out of the knees and legs.

As used in this specification, the term “hollow” of the knee shall mean the back of the knee.

As used in this specification, the term “passé” shall mean the bending of a leg at the knee while raising the foot of said leg, toes pointed, to pass the knee of the opposite leg.

As used in this specification, the term “point” shall mean lifting the heel of the foot such that part of the foot between the toes and the ankle forms an arch.

As used in this specification, the term “port de bras” shall refer to any specific movement of the arms.

As used in this specification, the term “tempo adagio” shall mean a slow music tempo of approximately 66-76 beats per minute.

As used in this specification, the term “tempo allegretto” shall mean a moderately fast music tempo of approximately 110-120 beats per minute.

As used in this specification, the term “tempo sostenendo” shall mean a musical tempo in which the notes are sustained as long as, or prolonged beyond, their full value in a smooth manner.

As used in this specification, the term “tempo valse” shall mean a musical tempo in triple time with a strong accent on the first beat.

### DETAILED DESCRIPTION OF A PREFERRED EMBODIMENT

The exercise method of this invention consists of a series of exercises, which is designed to accelerate the acquisition of proper ballet technique by conditioning the musculature and supporting proper posture and alignment. This method is referred to as the “Castillo Method.” The Castillo Method consists of performing a series of stretching protocols on the floor 4 in a predetermined series and number of repetitions. The exercise program is intended for completion of the entire set of exercises; however, any part of the exercise program may be eliminated to address the requirements of the student 2.

Ballet is learned visually and aurally. About 10% of each movement is done subconsciously by the motor cerebral cortex and the remaining 90% is actively performed by the brain and muscles coordinating responses. Thus, the dancer requires a great deal of concentration to perform a dance routine. The cerebellum is responsible for motor learning and control, coordination, precision and timing while the cerebrum is responsible for voluntary actions. It is desirable to increase the subconscious motor cerebral cortex aspect of each move and increase the brain power or concentration available to focus on the observable movements instead.

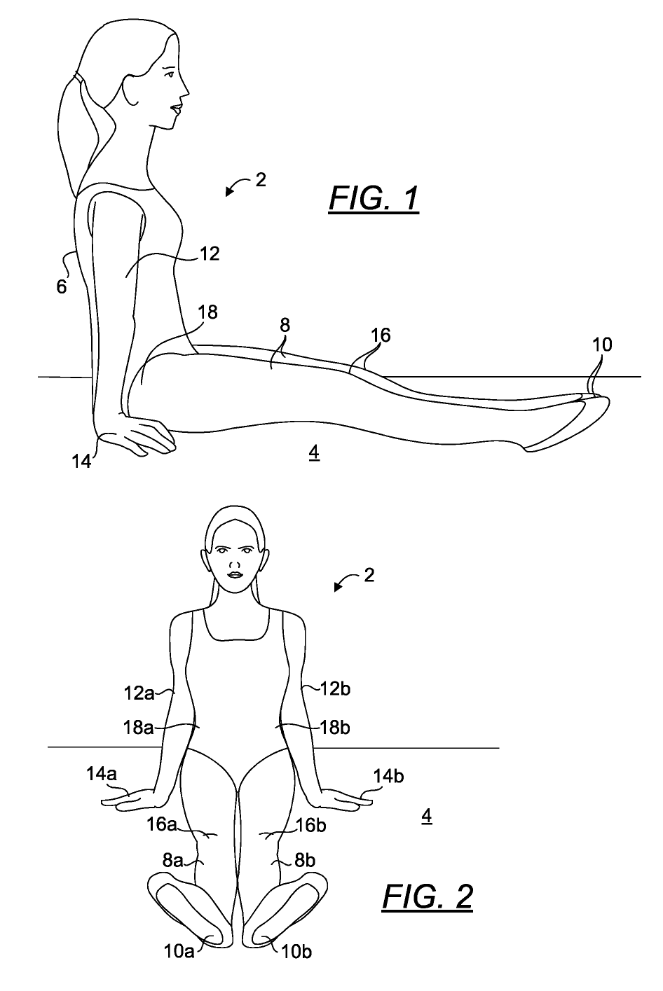

Referring to FIGS. 1 and 2, the first exercise is a tempo adagio stretch protocol in which the student 2 sits on the floor 4 with the spine 6 straight and the legs 8 extended forward, the feet 10 are pointed in first position, the arms 12 are straight at each respective side and the hands 14 are on the floor 4 facing outwardly in a relaxed manner such that the body weight is not born on the hands 14. The knees 16 and hips 18 are properly aligned and weight is properly distributed without dependency on a barre for alignment and equilibrium. The feet 10 are then flexed in the first position as depicted in FIG. 2 and returned to the pointed first position depicted in FIG. 1. This movement sequence is repeated three times such that a total of four repetitions are completed.

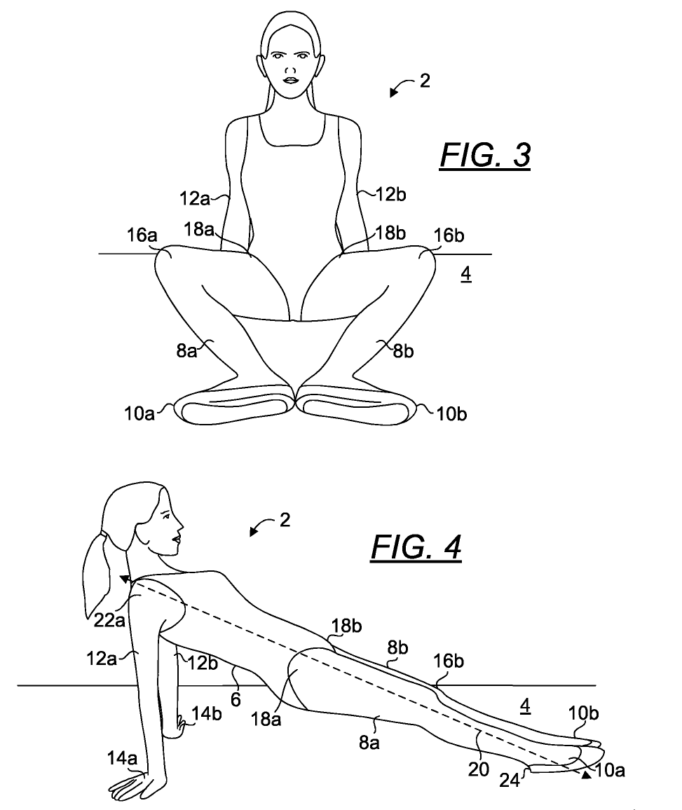

In the next part of this tempo adagio stretch protocol depicted in FIGS. 1 and 3, the student 2 flexes the feet 10 and bends the legs 8 into a demi-plié position as depicted in FIG. 3 (such that knees are raised off the floor) and returns (e.g., straightens) them to the pointed first position depicted in FIG. 1. This movement sequence is repeated three times such that a total of four repetitions are completed.

In the next part of this tempo adagio stretch protocol depicted in FIGS. 1 and 2, the feet 10 are once again pointed in first position, the arms 12 are straight at each respective side and the hands 14 are on the floor 4 facing outwardly in a relaxed manner such that the body weight is not born on the hands 14. The feet 10 are then flexed outwardly as depicted in FIG. 2 and returned to the pointed first position depicted in FIG. 1. This movement sequence is repeated three times such that a total of four repetitions are completed.

In the next part of this tempo adagio stretch protocol depicted in FIGS. 1 and 4, the hips 18 are lifted off the floor 4 to form a substantially straight line 20 from the shoulders 22 to the feet 10 while supporting the body weight on the hands 14 and the heels 24 of the pointed feet 10 (in first position) as depicted in FIG. 4. The knees 16, spine 6 and hips 18 are properly aligned and weight is properly distributed without dependency on a barre for alignment and equilibrium. The hips 18 are then lowered to the floor 4 to resume the position as shown in FIG. 1. This movement sequence is repeated three times such that a total of four repetitions are completed.

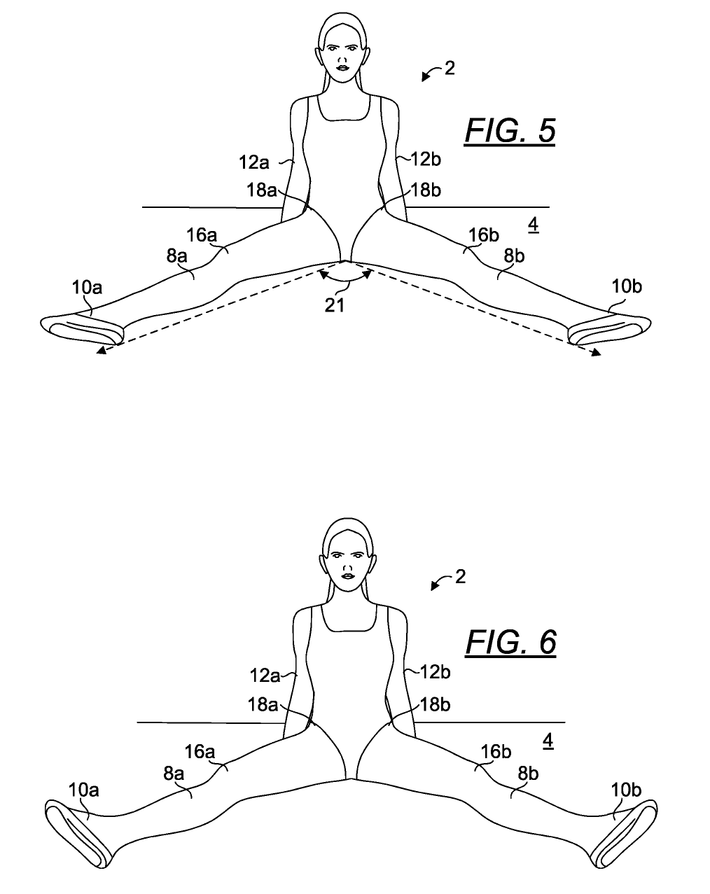

Second, the student 2 performs a demi-plié in écarté stretch protocol. This protocol is depicted in FIGS. 5 and 6 where the student 2 begins by sitting on the floor 4 as in FIG. 5, such that the spine 6 is straight (visible in FIG. 1) and the legs 8 are extended outwardly and spread wide apart from one another (preferably forming an angle 21 of greater than 100 degrees), the feet 10 are pointed in first position, the arms 12 are straight at each respective side and the hands 14 are on the floor 4 facing outwardly in a relaxed manner such that weight is not born on the hands 14 (as shown in FIG. 1). The knees 16 and hips 18 are properly aligned and weight is properly distributed without dependency on a barre for alignment and equilibrium. The feet 10 are then flexed (as depicted in FIG. 6) and pointed (as depicted in FIG. 5) in first position four times sequentially.

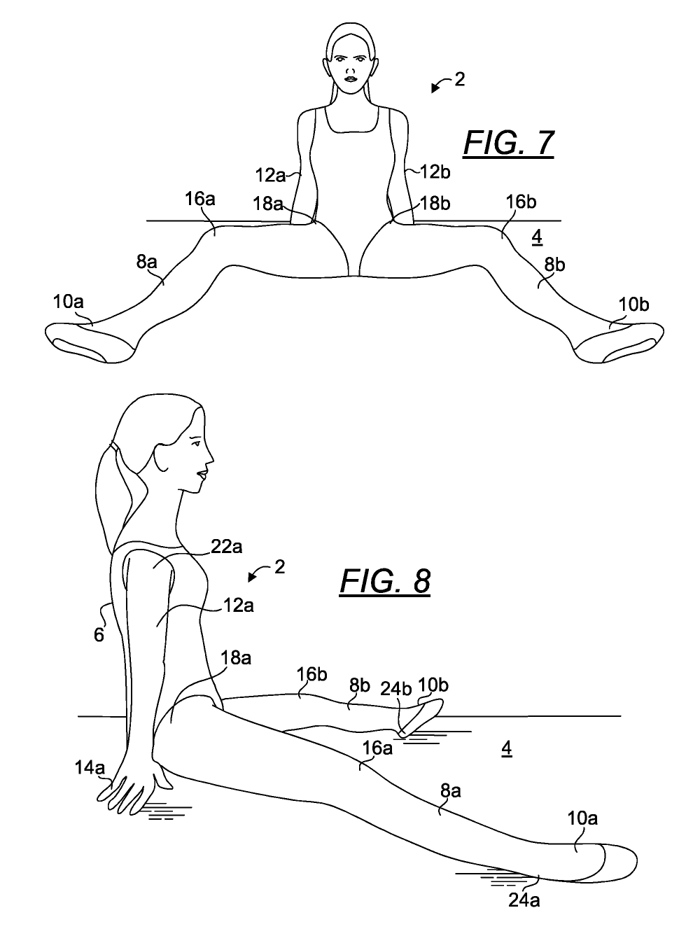

In the next part of this demi-plié in écarté stretch protocol depicted in FIGS. 5 and 7, the student 2 bends the legs 8 into a demi-plié in écarté position with the legs 8 separated and the knees raised off the floor 4 as depicted in FIG. 7. The legs 8 are straightened in the écarté position (as depicted in FIG. 5) and this sequence is repeated a total of four times sequentially.

In the next part of this demi-plié in écarté stretch protocol, the student 2 repeats the sequence depicted in FIGS. 5 and 6 as described above where the student 2 begins by sitting on the floor 4 as in FIG. 5, such that the feet 10 are then flexed (as depicted in FIG. 6) and pointed (as depicted in FIG. 5) in first position four times sequentially.

In the next part of this demi-plié in écarté stretch protocol depicted in FIGS. 5 and 8, the hips 18 are lifted off the floor 4 with the legs 8 fully extended and spread apart (preferably forming an angle 21 of greater than 100 degrees), feet pointed, as depicted in FIG. 8. The spine 6 is straight and the body weight is supported on the hands 14 and the heels 24 of the pointed feet 10 (FIG. 8), The hips 18 are then lowered to the floor 4 to resume the position as shown in FIG. 5, and this sequence is repeated three times for a total of four repetitions. Throughout this sequence, the knees 16, spine 6 and hips 18 are properly aligned and weight is properly distributed without dependency on a barre for alignment and equilibrium.

The student 2 then performs a second tempo adagio stretch protocol (FIGS. 1-4) followed by a second demi-plié in écarté stretch protocol (FIGS. 5-8).

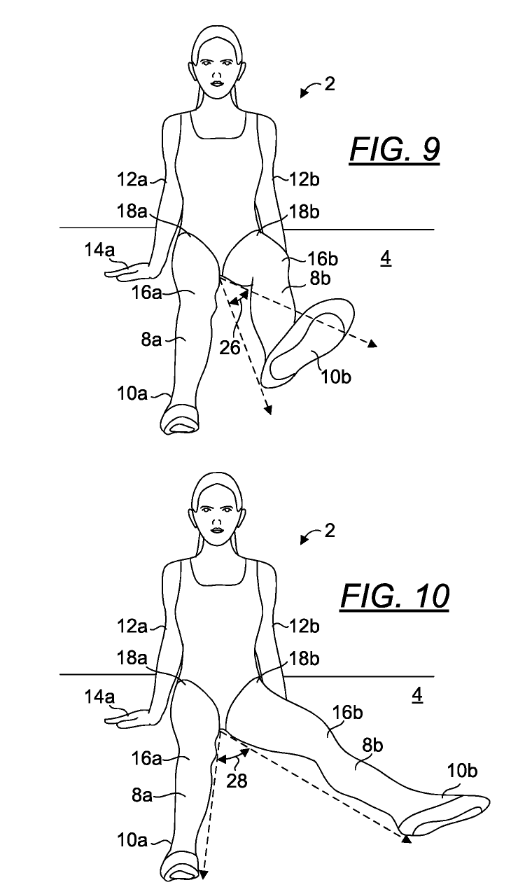

Third, the student 2 performs a tempo allegretto stretch protocol. Reference is made especially to FIGS. 1 and 9. The student 2 begins in the position depicted and described with reference to FIG. 1. Referring to FIG. 9, the left leg 8b (left foot 10b flexed) is lifted from the floor 4 upwardly at an angle 26 of about 20 degrees with respect to the floor 4 while maintaining the right leg 8a straight and on the floor 4 and the right foot 10a is pointed, and then the left foot 10b is pointed and the left leg 8b is returned to the floor 4 as depicted in FIG. 1. The knees 16 and hips 18 are properly aligned and weight is properly distributed without dependency on a barre for alignment and equilibrium. This movement sequence (depicted in FIGS. 1 and 9) is repeated three times for a total of four repetitions.

In the next portion of this tempo allegretto stretch protocol depicted in FIGS. 1 and 10, the student 2 begins in the position depicted and described with reference to FIG. 1. Referring to FIG. 10, the left foot 10b is flexed and the left leg 8b extends out to the left side slightly at about a 45-degree angle 28 with respect to the right leg 8a which remains straight and on the floor 4, and the right foot 10a pointed. Then the left foot 10b is pointed while the left leg 8b is returned to the floor 4, resuming the position as depicted in FIG. 1. The knees 16 and hips 18 are properly aligned and weight is properly distributed without dependency on a barre for alignment and equilibrium. This movement sequence is repeated three times for a total of four repetitions.

In the next portion of this tempo allegretto stretch protocol depicted in FIGS. 1 and 11, the left leg 8b is bent slightly so that the left foot 10b touches the inside of the right ankle 30a and the toes 32 of the left foot 10b and right foot 10a are pointed while maintaining the right leg 8a straight and on the floor 4, then the left foot 10b is returned to full extension next to the right leg 8a, as depicted in FIG. 1. The knees 16 and hips 18 are properly aligned and weight is properly distributed without dependency on a barre for alignment and equilibrium. This movement sequence is repeated three times for a total of four repetitions.

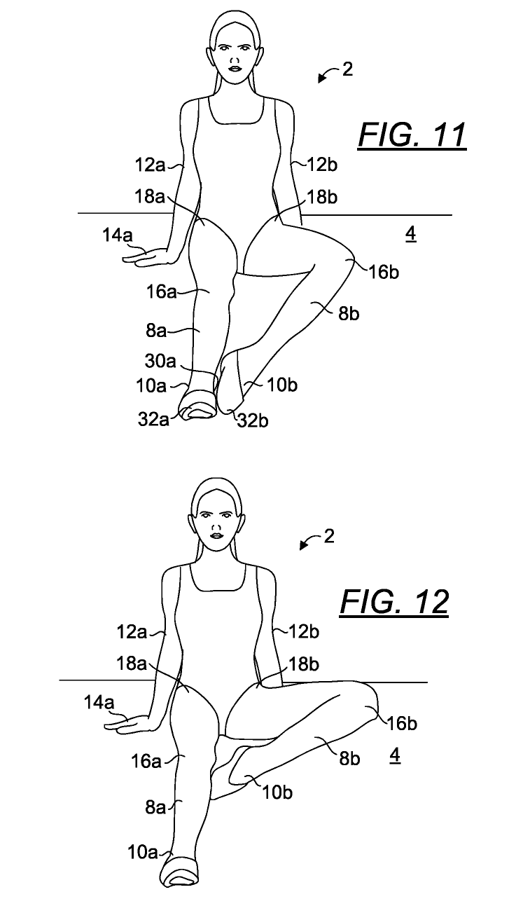

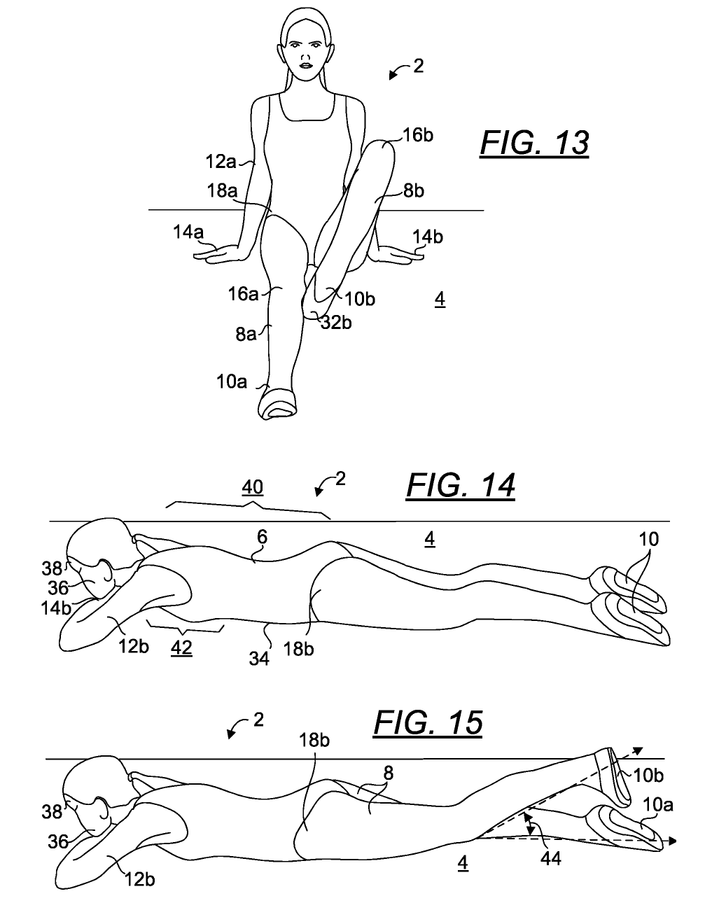

In the next portion of this tempo allegretto stretch protocol depicted in FIGS. 1, 12 and 13, the student 2 resumes the position shown in FIG. 1, in which the spine 6 is straight and the legs 8 are extended forward. The feet 10 are pointed, the arms 12 are straight at each respective side and the hands 14 are on the floor 4 facing outwardly in a relaxed manner such that weight is not born on the hands 14. The left foot 10b moves up the right leg 8a to the hollow of the right knee 16a, such that the left leg 8b is bent and the left knee 16b is extended outwardly, as depicted in FIG. 12. The left leg 8b is then straightened again, left foot 10b pointed, as depicted in FIG. 1. Referring to FIG. 13, the left foot 10b moves up the right leg 8a to the hollow of the right knee 16a and the left knee 16b is raised so that the left leg 8b remains bent but is facing forward, the toes 32 of the left foot 10b touching the floor. The left leg 8b then returns to full extension, the left foot 10b pointed, as depicted in FIG. 1. The movements are performed in the same manner a second time. Throughout this sequence, the knees 16 and hips 18 are properly aligned and weight is properly distributed without dependency on a barre for alignment and equilibrium.

These steps of the tempo allegretto stretch protocol (FIGS. 1 and 9-13) are then performed with the opposite leg 8a and foot 10a. The floor 4 exercises eliminate the requirement of rotating or changing sides (e.g., from left 10b to right foot 10a on the barre) and provide equilibrium of the body for all movements. Thus, the body is not forced to rebalance and proper posture is achieved without oblique hip 18 extension that tends to accompany the legs 8 on the barre.

In the next portion of this tempo allegretto stretch protocol depicted in FIGS. 14 and 15, the student 2 then switches positions to lie on the stomach 34 with the right 10a and left 10b feet extended straight behind and crossing the arms 12 in front while resting the chin 36 or forehead 38 on the hands 14 such that the torso 40 is lifted slightly and the chest 42 is still touching the floor 4 (FIG. 14). The left foot 10b is flexed and the left leg 8b is lifted straight up to an angle 44 of not more than 20 degrees with respect to the floor 4 while maintaining the right leg 8a extended (straight) and on the floor 4 as depicted in FIG. 15. The left leg 8b (left foot 10b pointed) is then lowered and returned to the floor 4 as depicted in FIG. 14. This movement sequence is repeated three times for a total of four repetitions.

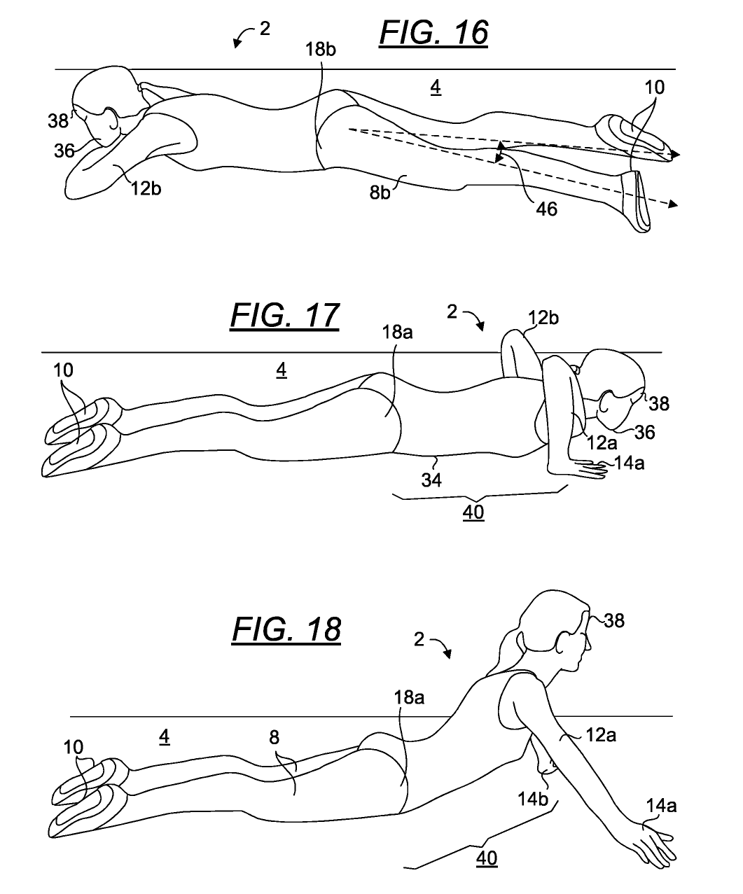

In the next portion of this tempo allegretto stretch protocol depicted in FIGS. 14 and 16, the student 2 resumes the position as shown in FIG. 14 by lying on the stomach 34 with the right 10a and left 10b feet extended straight behind and crossing the arms 12 in front while resting the chin 36 or forehead 38 on the hands 14 such that the torso 40 is lifted slightly and the chest 42 is still touching the floor 4. The knees 16, spine 6 and hips 18 are properly aligned and weight is properly distributed. The left leg 8b is extended to the left side at a substantially 45-degree angle 46 while the left foot 10b is pointed and turned outwardly such that the inside of the left leg 8b is pressing into the floor 4 (FIG. 16). This movement sequence is repeated three times for a total of four repetitions.

These stomach exercises (FIGS. 14-16) are then repeated using the right leg 8a for a total of four repetitions of each portion of the protocol performed on the stomach 34.

In the next portion of this tempo allegretto stretch protocol depicted in FIGS. 17 and 18, the student 2 lies on the stomach 34 while extending the right 10a and left 10b feet straight behind, the forehead 38 facing forward with the chin 36 resting on the floor 4, and the arms 12 in second position with the hands 14 pointed outwardly and the arms 12 bent (FIG. 17). The torso 40 is lifted slowly until the arms 12 extend straight (FIG. 18). Then the torso 40 is lowered back to the floor 4. This movement sequence is repeated three times for a total of four repetitions.

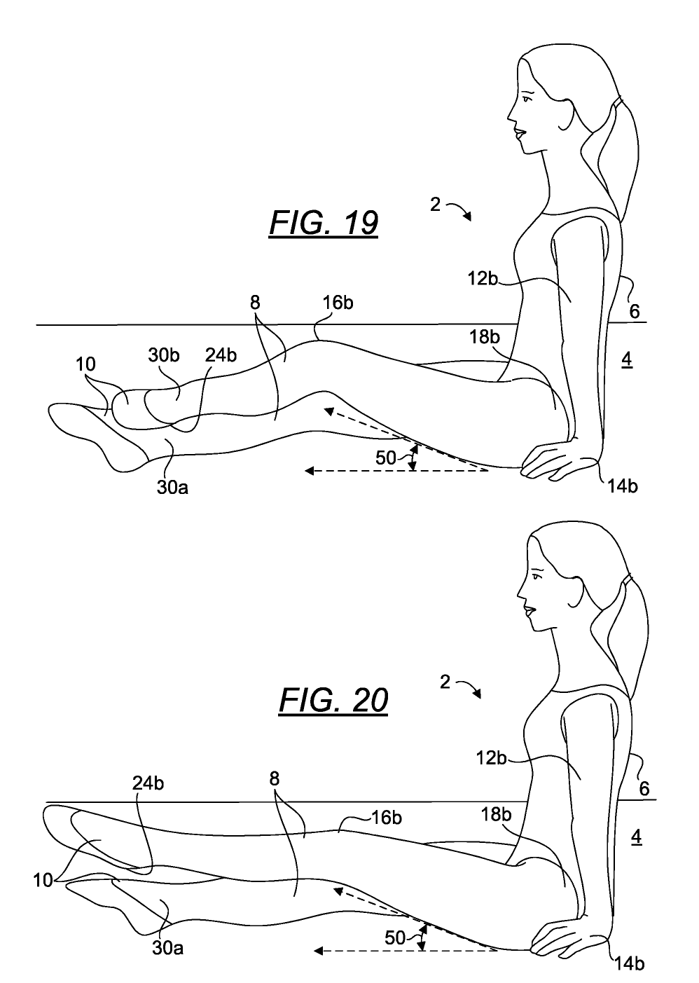

In the fourth stretch protocol depicted in FIGS. 1, 19 and 20, the tempo allegretto stretch protocol, the student 2 sits on the floor 4 such that the spine 6 is straight and the legs 8 are extended forwardly, the feet 10 are pointed in first position, the arms 12 are straight at each respective side and the hands 14 are on the floor 4 facing outwardly in a relaxed manner such that the body weight is not born on the hands 14, as shown in FIG. 1. The knees 16 and hips 18 are properly aligned and weight is properly distributed. The left foot 10b is flexed and lifted up to an angle 50 of not more than 5 degrees with respect to the floor 4 such that the left heel 24b is above the right ankle 30a and the left knee 16b is bent outwardly (FIG. 19). The left leg 8b is straightened and pointed, maintaining this same angle 50 with the right foot 10a pointed forward at full extension (FIG. 20). The left knee 16b is returned to the bent position depicted in FIG. 19 with the left foot 10b resting above the right ankle 30a and this movement is repeated three times for a total of four repetitions.

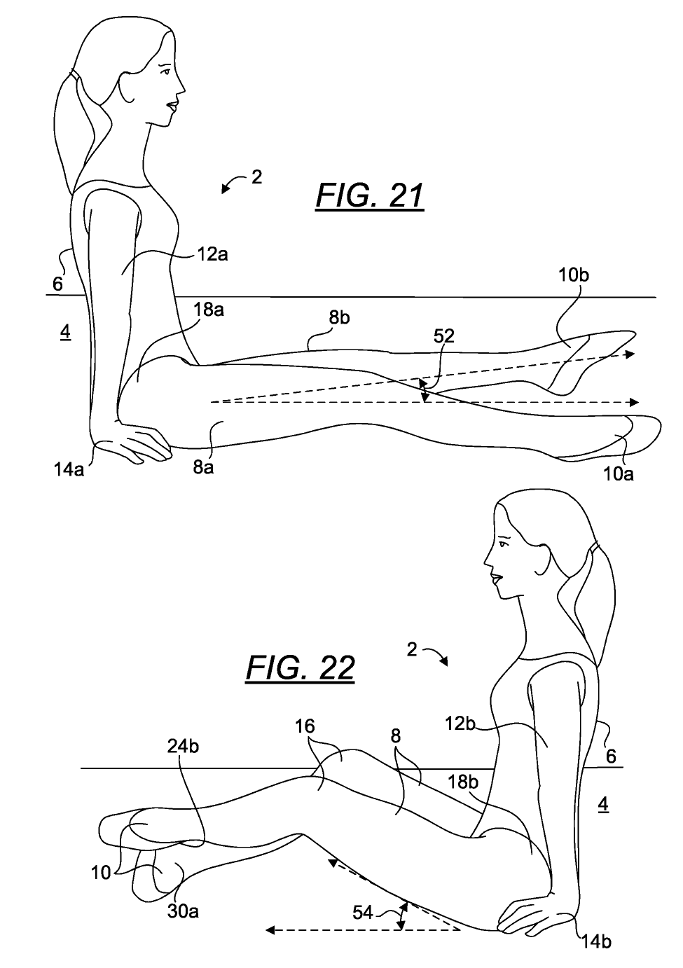

In the next portion of this stretch protocol depicted in FIGS. 1, 19, and 21 the student 2 resumes the position as shown in FIG. 1, sitting on the floor 4 such that the spine 6 is straight and the legs 8 are extended forwardly, the feet 10 are pointed, the arms 12 are straight at each respective side and the hands 14 are on the floor 4 facing outwardly in a relaxed manner such that the body weight is not born on the hands 14 and the left foot 10b is lifted up to an angle 50 of not more than 5 degrees with respect to the floor such that the left heel 24b is above the right ankle 30a and the left knee 16b is bent outwardly. The knees 16 and hips 18 are properly aligned and weight is properly distributed. The left leg 8b extends out to the left side slightly at about a 20 degree angle 52 with respect to the right leg 8a (FIG. 21). The left leg 8b is returned to the position as shown in FIG. 19. This movement sequence is repeated three times for a total of four repetitions.

This part of the tempo allegretto stretch protocol depicted in FIGS. 1 and 19-21 is repeated with the right foot 10a for a total of four repetitions.

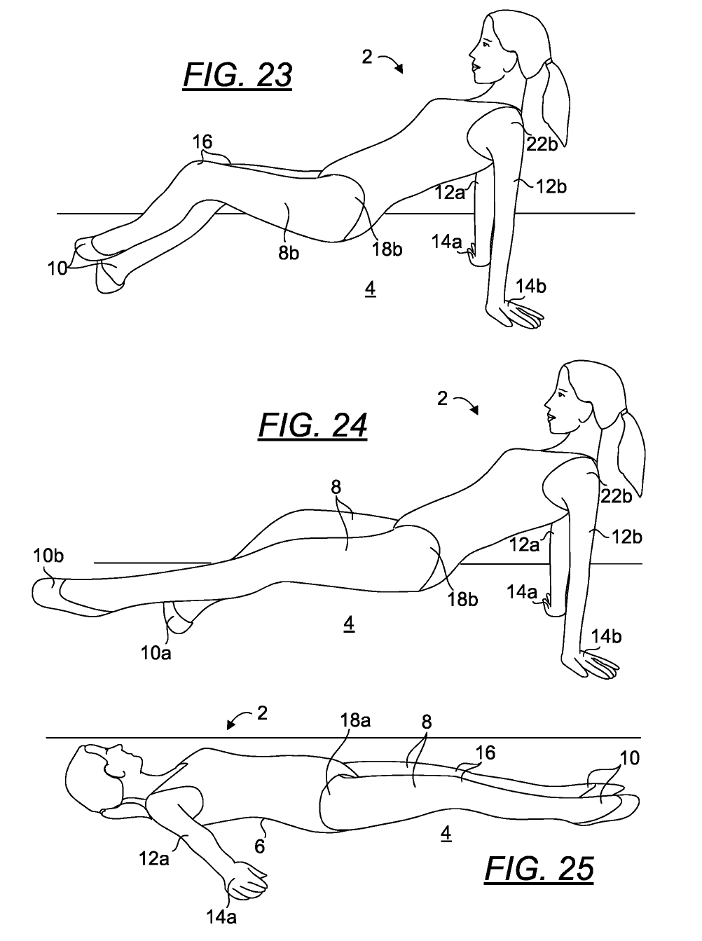

In the next part of this stretch protocol depicted in FIGS. 3, 22, 23, and 24, the student 2 sits on the floor 4 such that the spine 6 is straight, the arms 12 are straight at each respective side and the hands 14 are on the floor 4 facing outwardly in a relaxed manner such that the body weight is not born on the hands 14, and the legs 8 are bent into a demi-plié and the feet 10 are flexed as shown in FIG. 3. The left foot 10b is lifted up to an angle 54 of not more than 5 degrees with respect to the floor 4 such that the left heel 24b is above the right ankle 30a (FIG. 22). The hips 18 are lifted off the floor 4 while supporting the body weight on the hands 14 and right foot 10a (FIG. 23). The left leg 8b is straightened to full extension with respect to the right leg 8a and the left foot 10b is pointed (FIG. 24). The left leg 8b is returned to the position shown in FIG. 23 by bending the left leg 8b such that the left foot 10b rests above the right ankle 30a while keeping the hips 18 raised. This movement sequence is repeated three times for a total of four repetitions before the hips 18 are lowered to the floor 4, resuming the position shown in FIG. 22. This portion of the stretch protocol is repeated with the right leg 8a for a total of four repetitions.

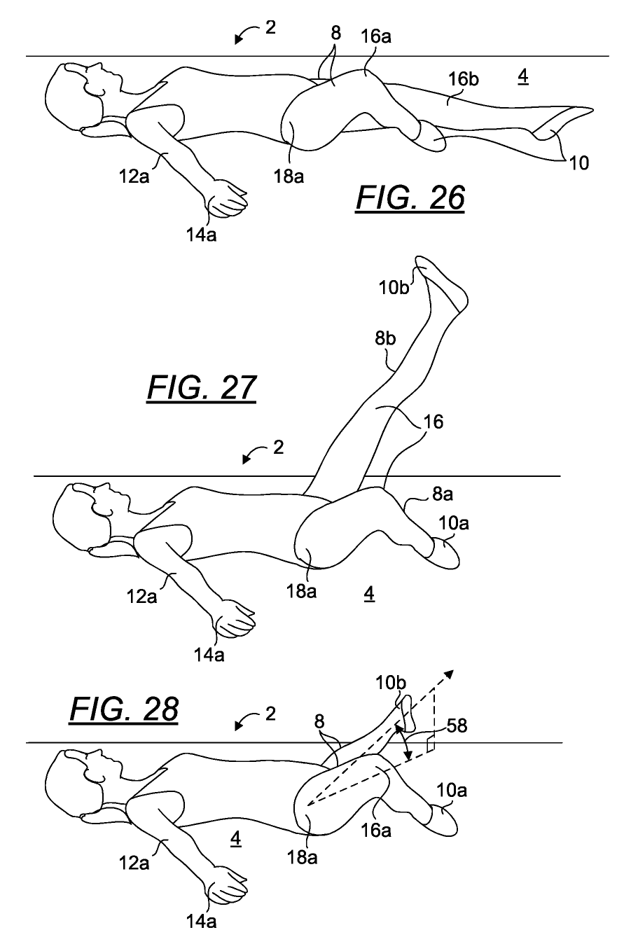

The fifth stretch protocol is the tempo valse stretch protocol and is depicted in FIGS. 25, 26, 27 and 28. The student 2 lies on the back on the floor 4 such that the spine 6 is straight and the legs 8 are extended, the arms 12 resting on the floor 4 in second position (FIG. 25). The knees 16, spine 6 and hips 18 are properly aligned and weight is properly distributed. The right leg 8a is bent into passé position en dehors, with the right foot 10a flexed and angled at the hollow of the left knee 16b (FIG. 26). The left leg 8b, fully extended, is lifted upwardly while flexing the left foot 10b (FIG. 27). The left leg 8b is lowered out to the left side slightly at about a 20-degree angle 58 with respect to the floor 4 while keeping the right hip 18a on the floor 4 (FIG. 28). The left leg 8b is lifted as shown in FIG. 27 and then lowered to the floor 4 (left foot 10a pointed) as depicted in FIG. 26. This movement sequence is repeated three times for a total of four repetitions.

This part of the tempo valse stretch protocol is repeated on the right side for a total of four repetitions.

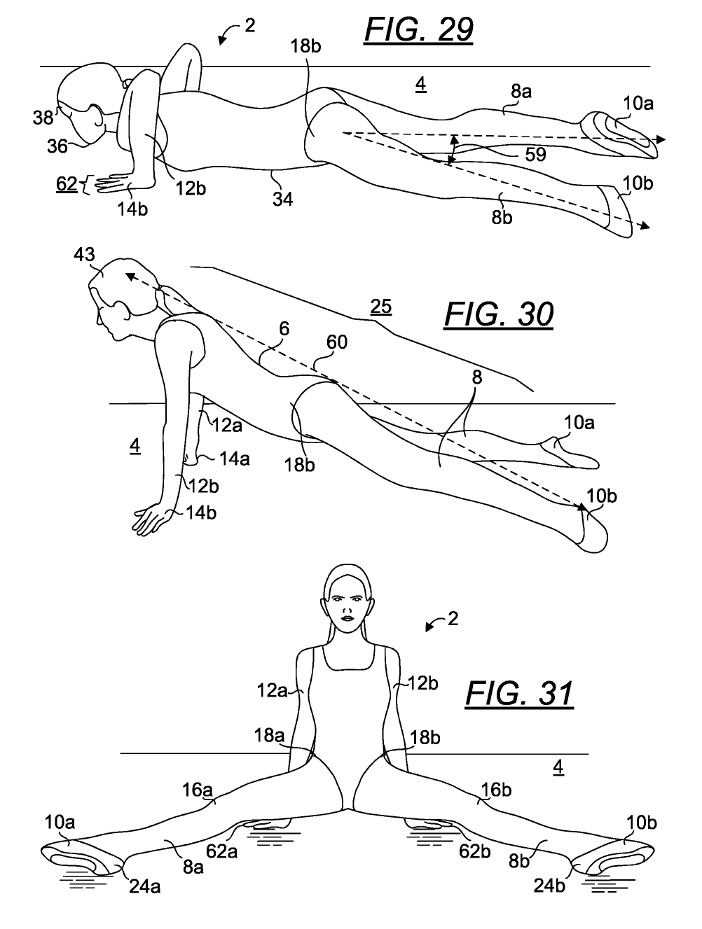

In the next part of the tempo valse stretch protocol depicted in FIGS. 17, 18, 29, and 30, the student 2 lies on the stomach 34 while extending the right 10a and left 10b feet straight behind, the forehead 38 facing forward with the chin 36 resting on the floor 4, and the arms 12 in second position with the hands 14 pointed outwardly and the arms 12 bent (FIG. 17). The left leg 8b is extended at about a 25-degree angle 59 with respect to the right leg 8a while externally rotating and flexing the left foot 10b such that the inside of the left foot 10b is pressing into the floor 4 and the arms 12 are in second position with the fingers 62 pointed outwardly and the arms 12 bent (FIG. 29). As depicted in FIG. 30, the body 25 is lifted off the floor 4 so that the body weight is supported on the hands 14 and feet 10, forming a substantially straight line 60 from the head 43 to the feet 10 and holding for one minute before lowering the body 25 and returning the left leg 8b next to the right leg 8a. The knees 16, spine 6 and hips 18 are properly aligned and weight is properly distributed. Next, the torso 40 is lifted off the floor 4 so that the weight of the torso 40 is supported on the hands 14, and the hips 18 stay on the floor 4 (FIG. 18). This position is held for one minute before lowering the torso to the floor 4 and repeating the entire sequence three times for a total of four repetitions. This movement sequence depicted in FIGS. 18, 29, 30 is repeated with the right leg 8a for a total of four repetitions.

Sixth, the student 2 performs the tempo sostendendo stretch protocol as depicted in FIGS. 5, 31, 32, 33 and 34. The student 2 sits on the floor 4 such that the spine 6 is straight and the legs 8 are extended forwardly and spread wide apart from one another, the feet 10 are pointed, and the arms 12 are straight next to the hips 18 at each respective side (FIG. 5). The hips 18 (pelvis 68) are lifted vertically off the floor 4 so that the body weight is supported evenly on the fingers 62 and the heels 24 of the feet 10 (FIG. 31). The knees 16, spine 6 and hips 18 are properly aligned and weight is properly distributed. The hips 18 are then slowly lowered to the floor.

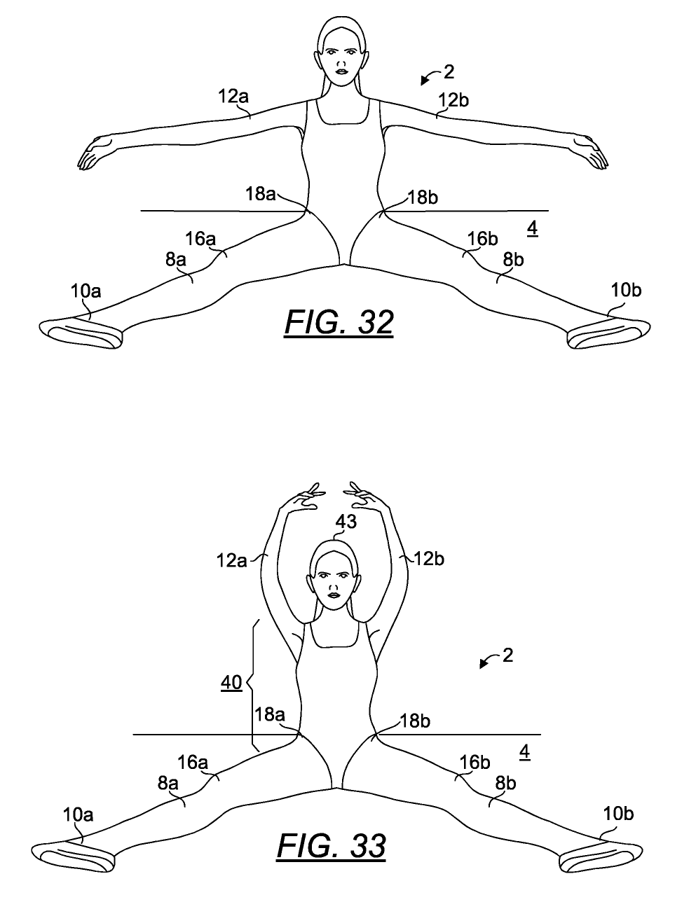

Returning to the position depicted and described with respect to FIG. 5, the arms 12 are moved into second position (FIG. 32) and then into fifth position above the head 43 but slightly forward of the torso 40 (FIG. 33).

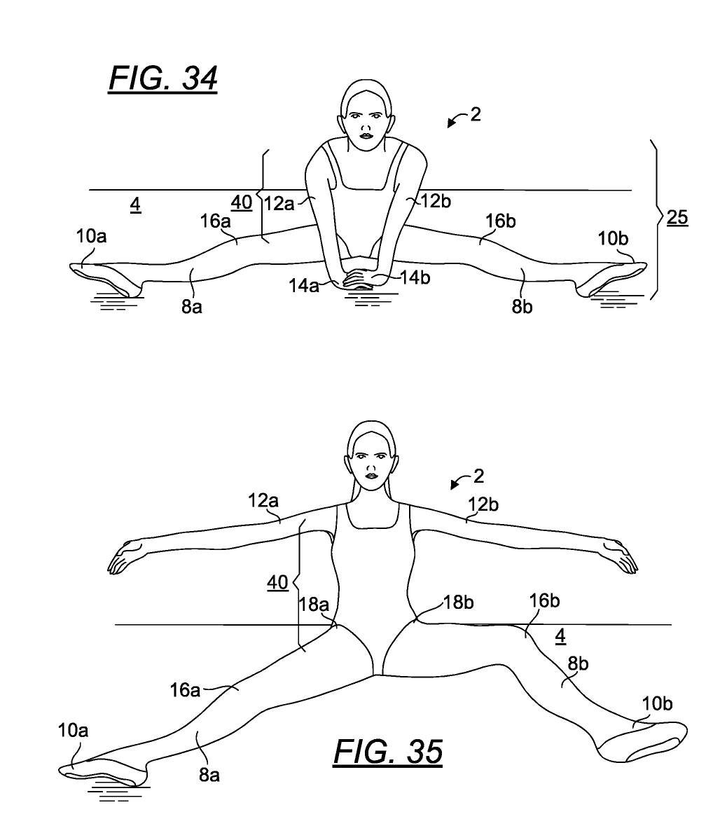

The hands 14 are then placed flat on the floor in front of the body 25 such that one is stacked upon the other and the hips 18 are lifted vertically off the floor 4 while shifting the torso 40 forward and keeping the spine 6 straight (FIG. 34). The hips 18 are lowered to the floor 4 slowly. The arms 12 are moved into fifth position such that the hands 14 are in front of the body (FIG. 33), then into second position (FIG. 32) and finally returned to the position as shown in FIG. 5, with the spine 6 straight and the legs 8 extended forwardly and spread wide apart from one another, the feet 10 pointed, the arms 12 straight at each respective side.

This part of the tempo sostenendo stretch protocol (depicted in FIGS. 5 and 31-34) is then performed a second time.

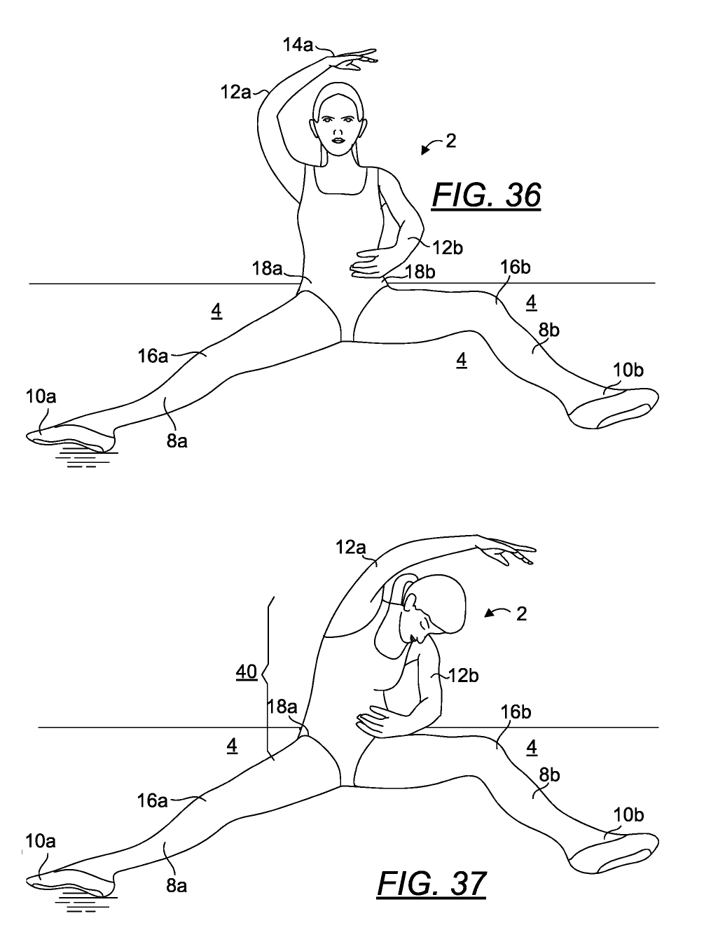

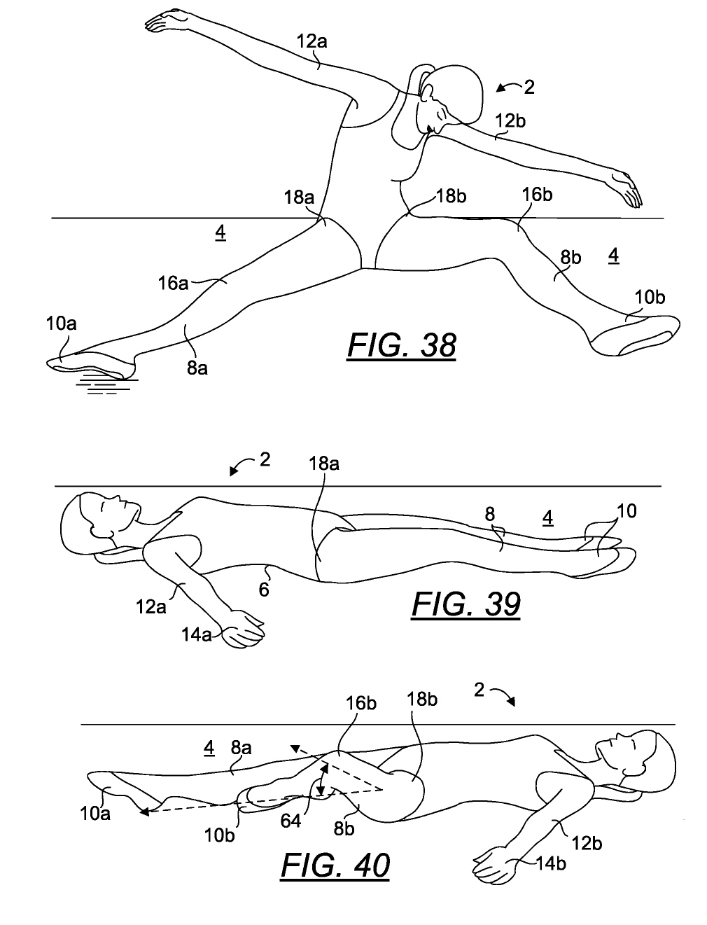

This next part of the tempo sostenendo stretch protocol is depicted in FIGS. 32 and 35-38. Returning to the position depicted and described with respect to FIG. 32, such that the student 2 is sitting on the floor 4 such that the spine 6 is straight and the legs 8 are extended forwardly and spread wide apart from one another, the feet 10 are pointed, the arms 12 in a second position, fingers 62 resting lightly on the floor 4, the left leg 8b is bent inwardly at the knee 16b into the demi-plié position (FIG. 35). The left arm 12b is lifted into the first position and the right arm 12a is lifted into the fifth position (FIG. 36). The torso 40 is bent sideways from the hip 18 towards the left knee 16b, keeping the right hip 18a firmly on the floor 4 while maintaining a straight spine 6 as depicted in FIG. 37. The arms 12 are lowered simultaneously into the second position (FIG. 38) and the torso 40 is raised so that the spine 6 is extended straight and vertically (FIG. 35). This sequence depicted in FIGS. 32 and 35-38 is repeated one time with the left leg 8b before repeating twice with the right leg 8a such that there are two repetitions with each leg 8.

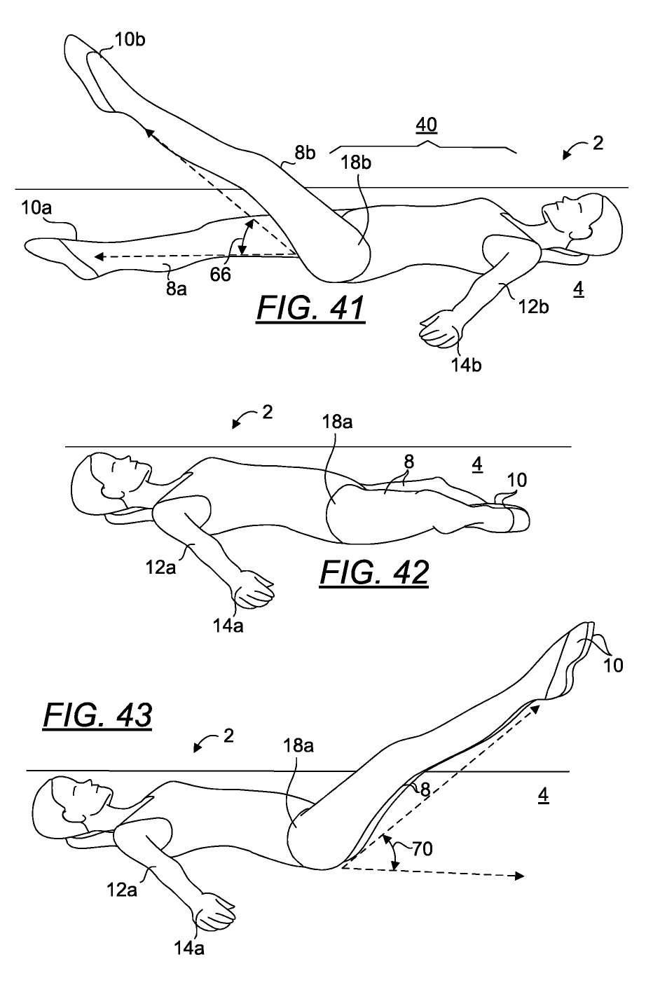

Seventh, the student 2 performs a tempo adagio stretch protocol as depicted in FIGS. 39, 40 and 41. The student 2 lies on the floor 4 on the back such that the spine 6 is straight and the legs 8 are extended and the feet 10 are pointed in the first position. The arms 12 are resting on the floor 4 in the second position and the palms of the hands 14 are facing the feet 10 (FIG. 39). The left leg 8b is bent until the left foot 10b is angled at the hollow of the right knee 16a and the left knee 16b is angled at about 45 degrees 64 with respect to the right leg 8a (FIG. 40). The left leg 8b is extended straight and is lifted vertically until it is disposed at an angle 66 from about 60 degrees to about 90 degrees with respect to the torso 40 (FIG. 41). The left leg 8b is lowered and bent until the left foot 10b is resting at the hollow of the right knee 16a (FIG. 40) and then returns to the position as shown in FIG. 39 with both legs 8 extended straight outward. This sequence depicted in FIGS. 39-41 is repeated one time with the left leg 8b before repeating twice with the right leg 8a such that there are two repetitions with each leg 8.

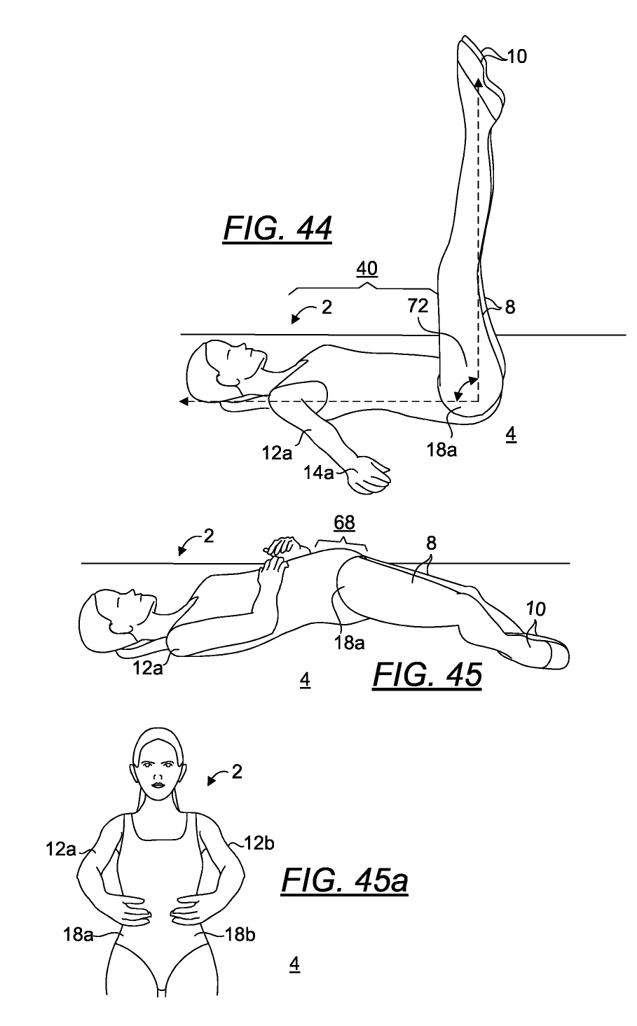

Next, the student 2 lies on the floor 4 on the back 6 such that the spine 6 is straight and the legs 8 are extended, the arms 12 resting on the floor 4 in the second position and the palms of the hands 14 are facing the feet 10 (FIG. 39). The legs 8 are bent into a grand plié while pointing the feet 10 (FIG. 42). Both legs 8 are extended simultaneously at an angle 70 of about 45 degrees with respect to the floor 4 (FIG. 43). The legs 8 are raised simultaneously until they are at an angle 72 of no more than about 90 degrees with respect to the torso 40 (FIG. 44). The legs 8 are then lowered to the floor 4 simultaneously and bent into a grand plié (FIG. 42). The legs 8 are extended straight with the feet 10 pointed (FIG. 39).

In the second part of the tempo adagio stretch protocol depicted in FIGS. 39, 42 and 45, the student 2 lies on the floor 4 such that the legs 8 are extended forwardly, the feet 10 are pointed and the arms 12 are resting on the floor 4 in the second position (FIG. 39). The legs 8 are bent into a grand plié while pointing the feet 10 (FIG. 42). The pelvis 68 is lifted in the grand plié position while the arms 12 are simultaneously moved into the first position (FIG. 45a) and this position is held for about one minute (FIG. 45). Then the pelvis 68 is lowered. This movement sequence is repeated three times for a total of four repetitions.

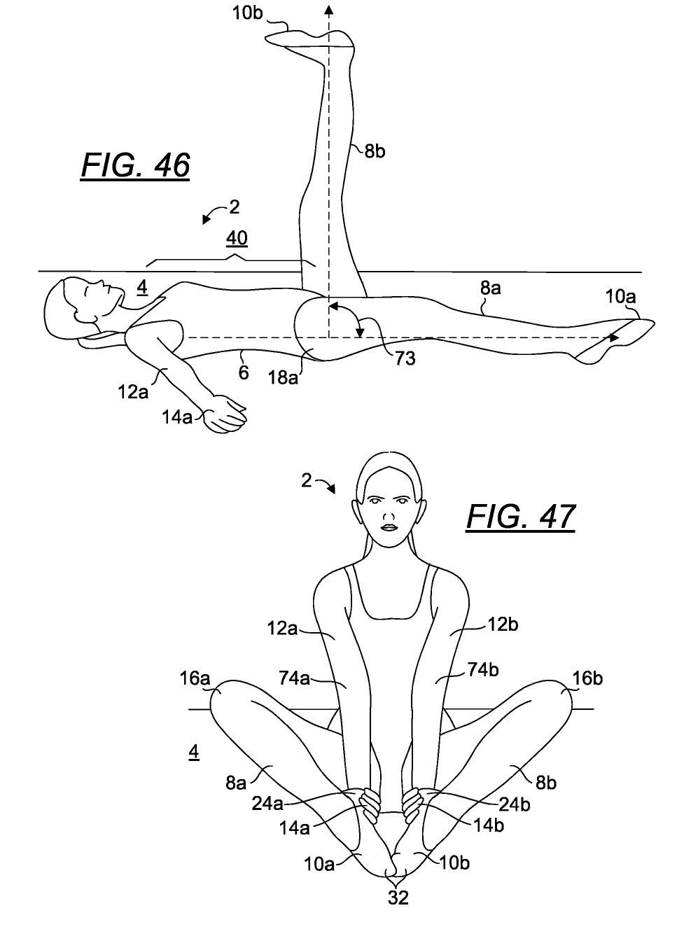

The eighth and final stretch protocol is the tempo allegretto stretch protocol depicted in FIGS. 39 and 46-49. The student 2 resumes the position as shown in FIG. 39 in which the student 2 lies on the floor 4 on the back such that the spine 6 is straight and the legs 8 are extended, the arms 12 are resting on the floor 4 in second position and the palms of the hands 14 are facing the feet 10. The left leg 8b, left foot 10b flexed, is lifted swiftly at an angle 73 of no more than about 90 degrees with respect to the torso 40 (FIG. 46). Then the left foot 10b is pointed and the left leg 8b is slowly lowered to the floor 4. This movement sequence is repeated three times for a total of four repetitions. This sequence depicted in FIGS. 39 and 46 is repeated with the right leg 8a for a total of four repetitions.

The student 2 then switches positions to lie on the stomach 34 (on the floor 4) with the legs 8 extended straight back, the feet 10 pointed and the arms 12 crossed in front with the forehead 38 or chin 36 resting on the arms 12 (FIG. 14). The left foot 10b is flexed and the left leg 8b is lifted straight up quickly (FIG. 15). Then the left foot 10b is pointed and lowered slowly. This movement sequence is repeated three times for a total of four repetitions, then repeated with the right leg 8a for a total of four repetitions.

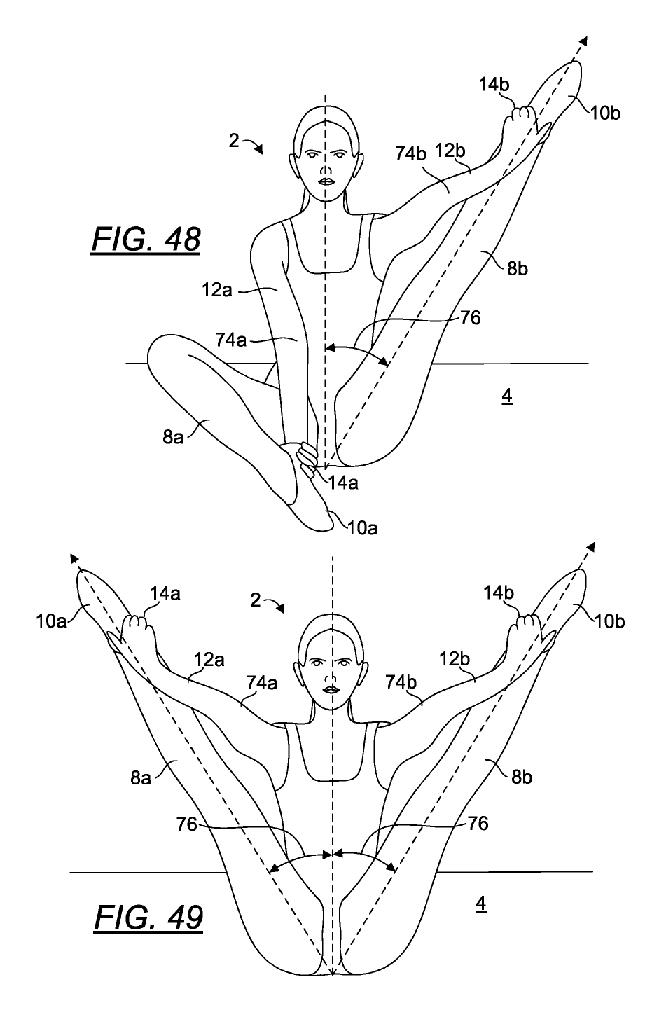

In the next portion of this protocol, the student 2 sits on the floor 4 such that the spine 6 is straight (as shown in FIG. 1), the legs 8 are bent, the feet 10 are pointed, and the bottoms of the feet 10 are facing inwardly and the toes are touching (FIG. 47). The student 2 grasps the bottom of the left heel 24b with the left hand 14b and the bottom of the right heel 24a with the right hand 14a such that the arms 12 are extended straight and the inside of the elbow 74 is facing outwardly (FIG. 47). The left leg 8b is lifted so that the leg 8b is extended at about a 45 degree angle 76 with respect to the torso while keeping the spine 6 straight (FIG. 48) and the left foot 10b pointed. This position is held for at least six seconds. Then the left leg 8b is bent in at the knee 16b and returned to the position depicted in FIG. 47 where the toes are touching the floor. This movement sequence is repeated one time with the right leg 8a. Then, both legs 8 are lifted simultaneously such that the legs 8 are extended straight and spread wide apart from one another keeping the spine 6 straight and the feet 10 pointed (FIG. 49). This position is held for at least six seconds. Then the legs 8 are bent and lowered to the floor 4 and the hands 14 are released from the feet 10.

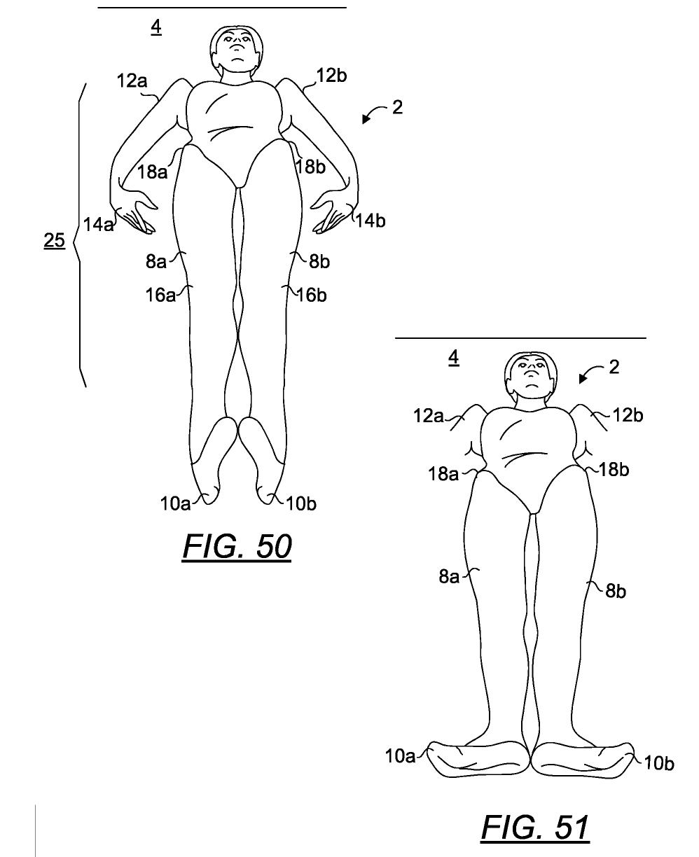

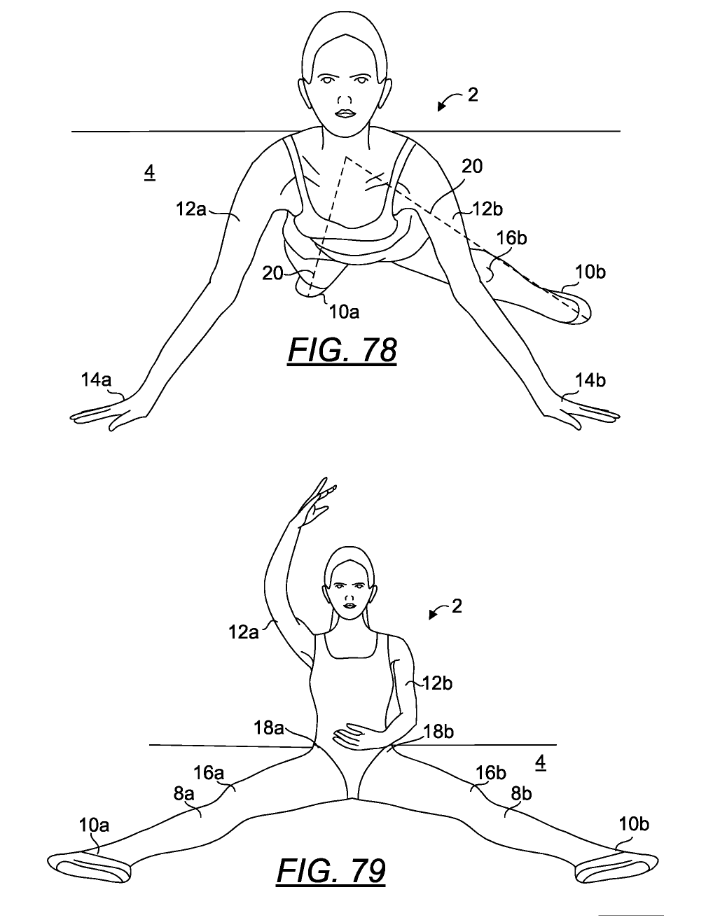

These exercise protocols may also be performed at a more advanced level when the student's muscles are developed for completing the more vigorous exercise routines. These advanced exercises will be described below with reference to FIGS. 50 through 86. As will be readily recognized, these are modifications to the previously described exercises.

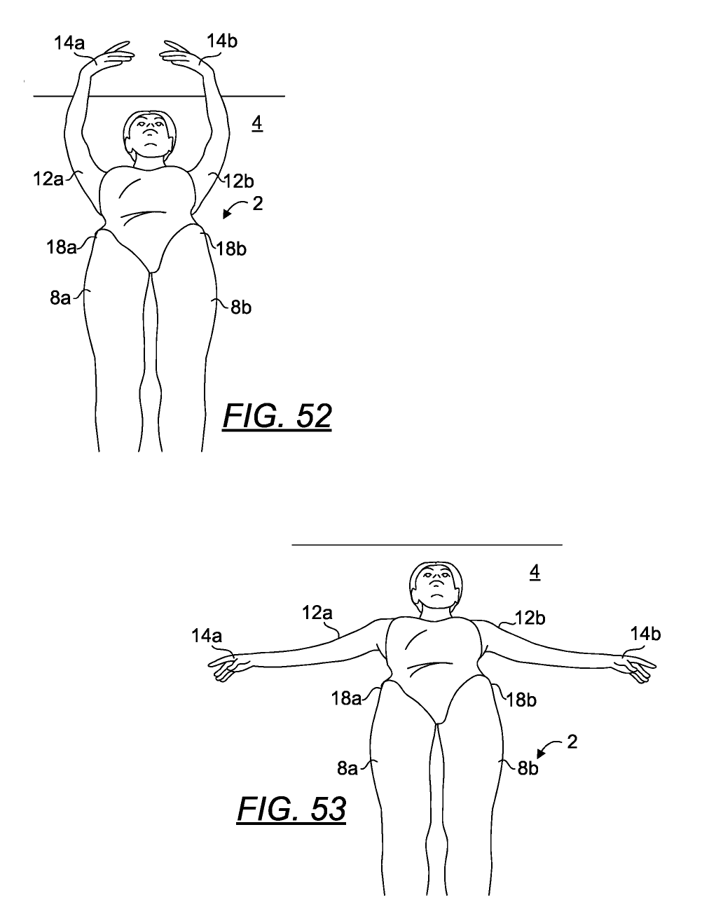

Referring to FIGS. 50, 51 and 52, the first advanced exercise is a tempo adagio stretch protocol in which the student 2 lies on the floor 4 with the spine 6 straight and the legs 8 extended forward, the feet 10 are pointed in first position, the arms 12 are curved at each respective side and the hands 14 are on the floor 4 facing inwardly toward the body 25. The knees 16 and hips 18 are properly aligned and weight is properly distributed without dependency on a barre for alignment and equilibrium (FIG. 50). The feet 10 are then flexed in the first position as depicted in FIG. 51 and returned to the pointed first position depicted in FIG. 50. This movement sequence is repeated three times such that a total of four repetitions are completed. During the course of these four repetitions, the arms 12 move steadily into first position as shown in FIG. 52.

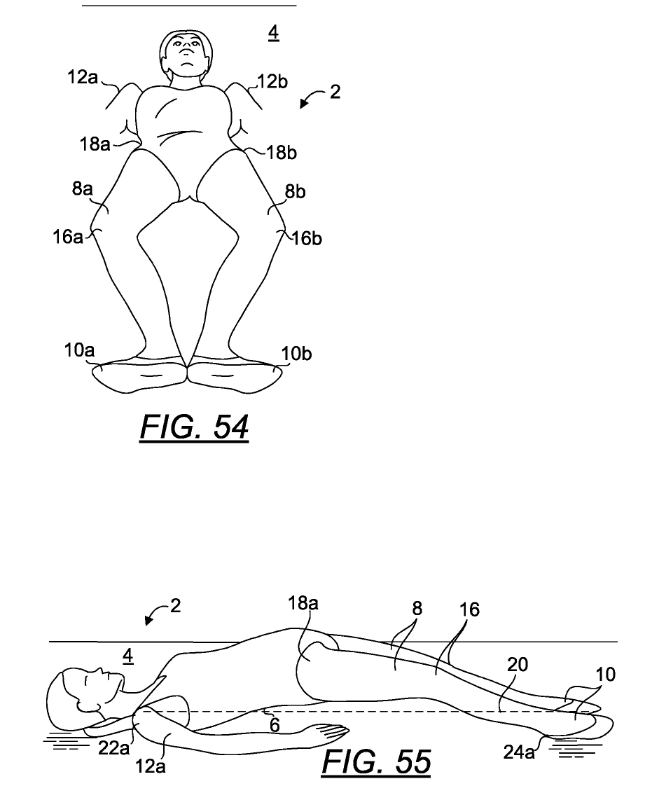

In the next part of the advanced tempo adagio stretch protocol, depicted in FIGS. 50, 53 and 54, the student 2 once again begins in the position depicted and described with reference to FIG. 50. The student 2 bends the legs 8 into a demi-plié position as depicted in FIG. 54 (such that knees 16 are raised off the floor) and returns (e.g., straightens) them to the pointed first position depicted in FIG. 50. This movement sequence is repeated three times such that a total of four repetitions are completed. During the course of the four repetitions, the arms 12 move steadily into second position as shown in FIG. 53.

In the next part of this advanced tempo adagio stretch protocol depicted in FIGS. 50, 51 and 52, the student 2 begins in the position depicted and described with reference to FIG. 50. The feet 10 are then flexed in the first position as depicted in FIG. 51 and returned to the pointed first position depicted in FIG. 50. This movement sequence is repeated three times such that a total of four repetitions are completed. During the course of the four repetitions, the arms 12 move steadily into first position as shown in FIG. 52.

In the next part of this advanced tempo adagio stretch protocol depicted in FIGS. 50 and 55, the student 2 begins in the position depicted and described with reference to FIG. 50. The hips 18 are lifted vertically off the floor 4 to form a substantially straight line 20 from the shoulders 22 to the pointed feet 10 while supporting the body weight on the shoulders 22 and the heels 24 of the feet 10 (in first position); the arms 12 are lowered near the sides of the body 25 during the course of the four repetitions as depicted in FIG. 55. The knees 16, spine 6 and hips 18 are properly aligned and weight is properly distributed without dependency on a barre for alignment and equilibrium. The hips 18 are then lowered to the floor 4 to resume the position as shown in FIG. 50. This movement sequence is repeated three times such that a total of four repetitions are completed.

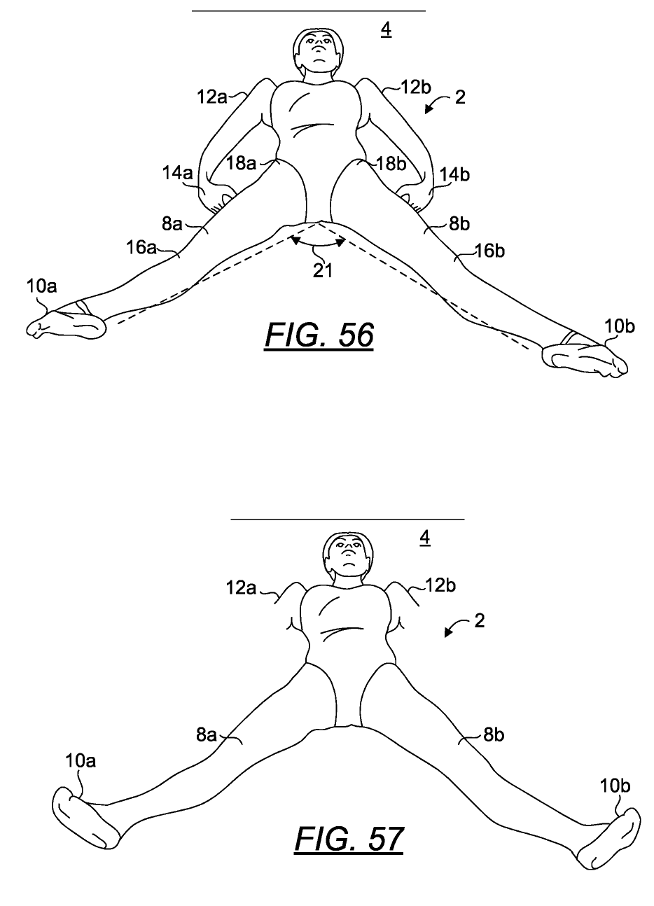

Second, the student 2 performs an advanced demi-plié in écarté stretch protocol. This protocol is depicted in FIGS. 52 and 56-58. The student 2 lies on the floor 4 with the spine 6 straight and the legs 8 extended forward and spread wide apart from one another (preferably forming an angle 21 of greater than 100 degrees), the feet 10 are pointed in first position, the arms 12 are curved at each respective side and the hands 14 are on the floor 4 facing inwardly toward the body 25. The knees 16 and hips 18 are properly aligned and weight is properly distributed without dependency on a barre for alignment and equilibrium (FIG. 56). The feet 10 are then flexed in the second position as depicted in FIG. 57 and returned to the pointed second position depicted in FIG. 56. This movement sequence is repeated three times such that a total of four repetitions are completed. During the course of these four repetitions, the arms 12 move steadily into first position as shown in FIG. 52.

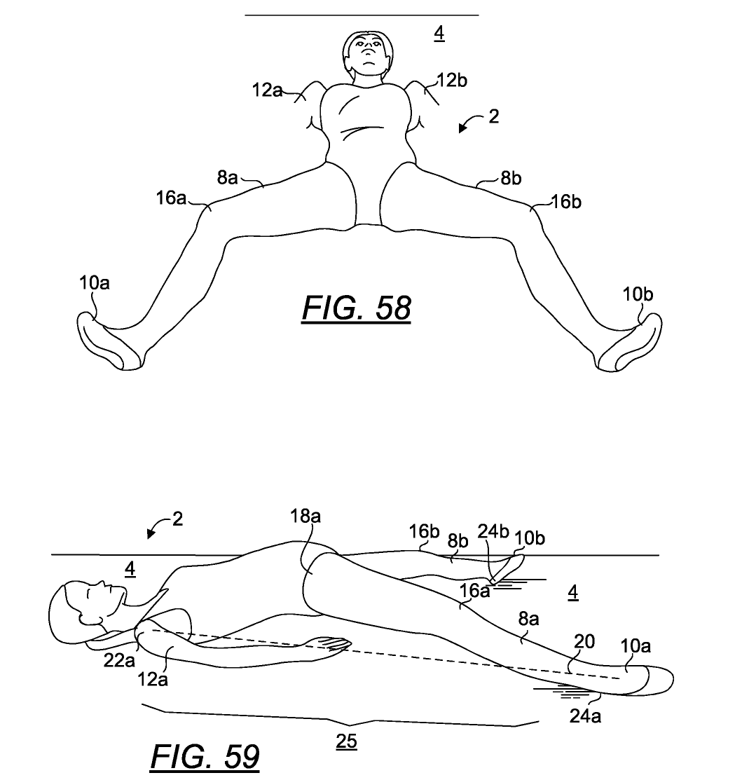

In the next part of the advanced demi-plié in écarté stretch protocol depicted in FIGS. 53, 56 and 58, the student 2 once again begins in the position depicted and described with reference to FIG. 56. The student 2 bends the legs 8 into a demi-plié position as depicted in FIG. 58 (such that knees are raised off the floor) and returns (e.g., straightens) them to the pointed first position depicted in FIG. 56. This movement sequence is repeated three times such that a total of four repetitions are completed. During the course of the four repetitions, the arms 12 move steadily into second position as shown in FIG. 53.

In the next part of this advanced demi-plié in écarté stretch protocol, the student 2 repeats the sequence depicted in FIGS. 52, 56 and 57, where the student 2 begins in the position depicted and described with reference to FIG. 56. The feet 10 are then flexed in the second position as depicted in FIG. 57 and returned to the pointed second position depicted in FIG. 56. This movement sequence is repeated three times such that a total of four repetitions are completed. During the course of these four repetitions, the arms 12 move steadily into first position as shown in FIG. 52.

In the next part of this advanced demi-plié in écarté stretch protocol depicted in FIGS. 56 and 59, the student 2 begins in the position depicted and described with reference to FIG. 56. The hips 18 are lifted vertically off the floor 4 to form a substantially straight line 20 from the shoulders 22 to the pointed feet 10 while supporting the body weight on the shoulders 22 and the heels 24 of the feet 10 (pointed in second position) and moving the arms 12 back to the position near the sides of the body 25 as depicted in FIG. 59 during the course of the four repetitions. The knees 16, spine 6 and hips 18 are properly aligned and weight is properly distributed without dependency on a barre for alignment and equilibrium. The hips 18 are then lowered to the floor 4 to resume the position as shown in FIG. 56. This movement sequence is repeated three times such that a total of four repetitions are completed.

The student 2 then performs a second advanced tempo adagio stretch protocol (FIGS. 50-55) followed by a second demi-plié in écarté stretch protocol (FIGS. 52, 53 and 56-59).

Third, the student 2 performs an advanced tempo allegretto stretch protocol. Reference is made especially to FIGS. 50 and 60. The student 2 begins in the position depicted and described with reference to FIG. 50. Referring to FIG. 60, the left leg 8b (left foot 10b flexed) is lifted from the floor 4 upwardly at an angle 26 of about 20 degrees with respect to the floor 4 while maintaining the right leg 8a straight and on the floor 4 and the right foot 10a is pointed. Then the left foot 10b is pointed and the left leg 8b is returned to the floor 4 as depicted in FIG. 50. The knees 16 and hips 18 are properly aligned and weight is properly distributed without dependency on a barre for alignment and equilibrium. This movement sequence (depicted in FIGS. 50 and 60) is repeated three times for a total of four repetitions. During the course of these repetitions, the left arm 12b is steadily raised to the second position and the right arm 12a is steadily lifted to the first position.

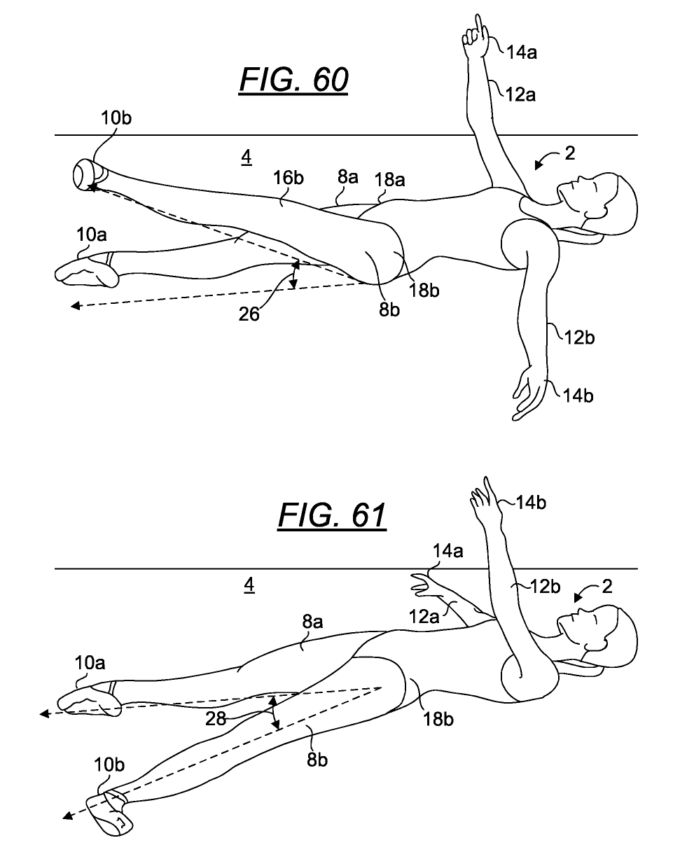

In the next portion of this advanced tempo allegretto stretch protocol depicted in FIGS. 50 and 61, the student 2 begins in the position depicted and described with reference to FIG. 50. Referring to FIG. 61, the left foot 10b is flexed and the left leg 8b is extended out to the left side slightly at about a 45-degree angle 28 with respect to the right leg 8a which remains straight and on the floor 4 and the right foot 10a pointed. Then the left foot 10b is pointed while the left leg 8b is returned next to the right leg 8a, resuming the position as depicted in FIG. 50. The knees 16 and hips 18 are properly aligned and body weight is properly distributed without dependency on a barre for alignment and equilibrium. This movement sequence is repeated three times for a total of four repetitions. During the course of these repetitions, the left arm 12b is lifted into the first position and the right arm 12a is lowered to the second position. The student 2 then returns to the position depicted and described with reference to FIG. 50.

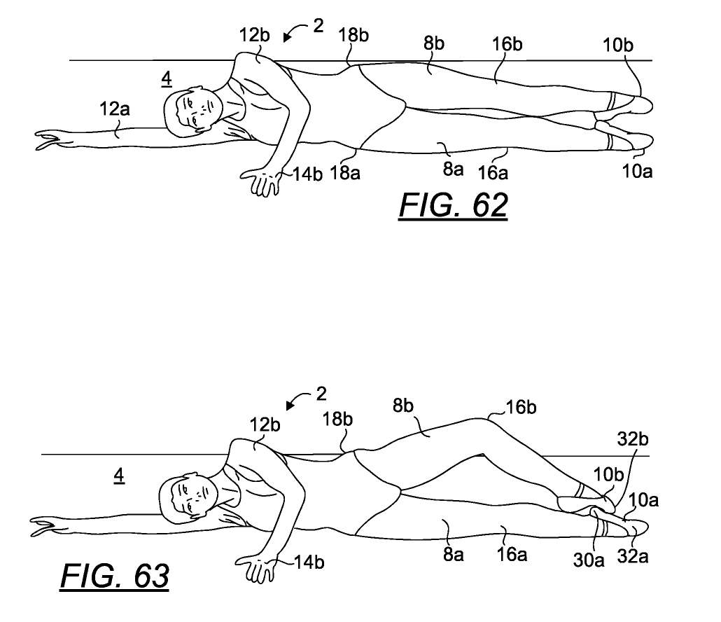

In the next portion of this advanced tempo allegretto stretch protocol depicted in FIGS. 62 and 63, the student 2 switches positions to lie on the right side of the body 25 on the floor 4 such that the right arm 12a is extended straight, the head 37 is resting on the right arm 12a, the left hand 14b is resting on the floor 4 in front of the torso 40 to help keep balance, the left hip 18b and left leg 8b are stacked on top of the right hip 18a and right leg 8a and the feet 10 are pointed in first position. The left leg 8b is bent slightly so that the left foot 10b touches the inside of the right ankle 30a and the toes 32 of the left foot 10b and right foot 10a are pointed while maintaining the right leg 8a straight and on the floor 4 (FIG. 63), then the left foot 10b is returned to full extension on the right leg 8a, as depicted in FIG. 62. The knees 16 and hips 18 are properly aligned and weight is properly distributed without dependency on a barre for alignment and equilibrium. This movement sequence is repeated three times for a total of four repetitions.

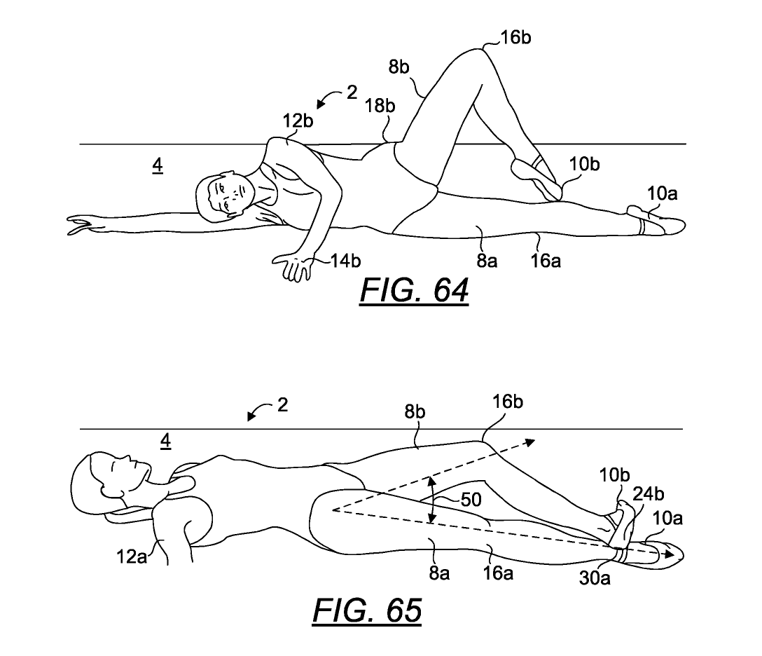

In the next portion of this advanced tempo allegretto stretch protocol depicted in FIGS. 62 and 64, the student 2 resumes the position as depicted and described in FIG. 62. The left foot 10b moves up the right leg 8a to the hollow of the right knee 16a, such that the left leg 8b is bent and the left knee 16b is extended outwardly, as depicted in FIG. 64. The left leg 8b is then straightened again, left foot 10b pointed, as depicted in FIG. 62. The movements are performed in the same manner a second time. Throughout this sequence, the knees 16 and hips 18 are properly aligned and weight is properly distributed without dependency on a barre for alignment and equilibrium.

These steps of the tempo allegretto stretch protocol (FIGS. 50 and 60-64) are then performed with the opposite leg 8a and foot 10a. The floor 4 exercises eliminate the requirement of rotating or changing sides (e.g., from left 10b to right foot 10a on the barre) and provide equilibrium of the body for all movements. Thus, the body 25 is not forced to rebalance and proper posture is achieved without oblique hip 18 extension that tends to accompany the legs 8 on the barre.

In the next portion of this advanced tempo allegretto stretch protocol depicted in FIGS. 14 and 15, the student 2 then switches positions to lie on the stomach 34 with the right 10a and left 10b feet extended straight behind and crossing the arms 12 in front while resting the chin 36 or forehead 38 on the hands 14 such that the torso 40 is lifted slightly and the chest 42 is still touching the floor 4 (FIG. 14). The left foot 10b is flexed and the left leg 8b is lifted straight up to an angle 44 of not more than 20 degrees with respect to the floor 4 while maintaining the right leg 8a extended (straight) and on the floor 4 as depicted in FIG. 15. The left foot 10b is pointed and the left leg 8b is then lowered and returned to the floor 4 as depicted in FIG. 14. This movement sequence is repeated three times for a total of four repetitions.

In the next portion of this advanced tempo allegretto stretch protocol depicted in FIGS. 14 and 16, the student 2 resumes the position as shown in FIG. 14 by lying on the stomach 34 with the right 10a and left 10b feet extended straight behind and crossing the arms 12 in front while resting the chin 36 or forehead 38 on the hands 14 such that the torso 40 is lifted slightly and the chest 42 is still touching the floor 4. The knees 16, spine 6 and hips 18 are properly aligned and weight is properly distributed. The left leg 8b is extended to the left side at a substantially 45-degree angle 46 while the left foot 10b is pointed and turned outwardly such that the inside of the left leg 8b is pressing into the floor 4 (FIG. 16). This movement sequence is repeated three times for a total of four repetitions.

In the next portion of this advanced tempo allegretto stretch protocol depicted in FIGS. 62 and 63, the student 2 switches positions to lie on the right side of the body 25 on the floor 4 such that the right arm 12a is extended straight, the head 37 is resting on the right arm 12a, the left hand 14b is resting on the floor in front of the torso 40 to help keep balance, the left hip 18b and left leg 8b are stacked on top of the right hip 18a and right leg 8a and the feet 10 are pointed in first position. The left leg 8b is bent slightly so that the left foot 10b touches the inside of the right ankle 30a and the toes 32 of the left foot 10b and right foot 10a are pointed while maintaining the right leg 8a straight and on the floor 4 (FIG. 63), then the left foot 10b is returned to full extension on the right leg 8a, as depicted in FIG. 62. The knees 16 and hips 18 are properly aligned and weight is properly distributed without dependency on a barre for alignment and equilibrium. This movement sequence is repeated three times for a total of four repetitions.

In the next portion of this advanced tempo allegretto stretch protocol depicted in FIGS. 62 and 64, the student 2 resumes the position as depicted and described in FIG. 62. The left foot 10b moves up the right leg 8a to the hollow of the right knee 16a, such that the left leg 8b is bent and the left knee 16b is extended outwardly, as depicted in FIG. 64. The left leg 8b is then straightened again, left foot 10b pointed, as depicted in FIG. 62. The movements are performed in the same manner a second time. Throughout this sequence, the knees 16 and hips 18 are properly aligned and weight is properly distributed without dependency on a barre for alignment and equilibrium.

These steps of the tempo allegretto stretch protocol (FIGS. 14-16, 62-64) are then performed with the opposite leg 8a and foot 10a. The floor 4 exercises eliminate the requirement of rotating or changing sides (e.g., from left 10b to right foot 10a on the barre) and provide equilibrium of the body for all movements. Thus, the body is not forced to rebalance and proper posture is achieved without oblique hip 18 extension that tends to accompany the legs 8 on the barre.

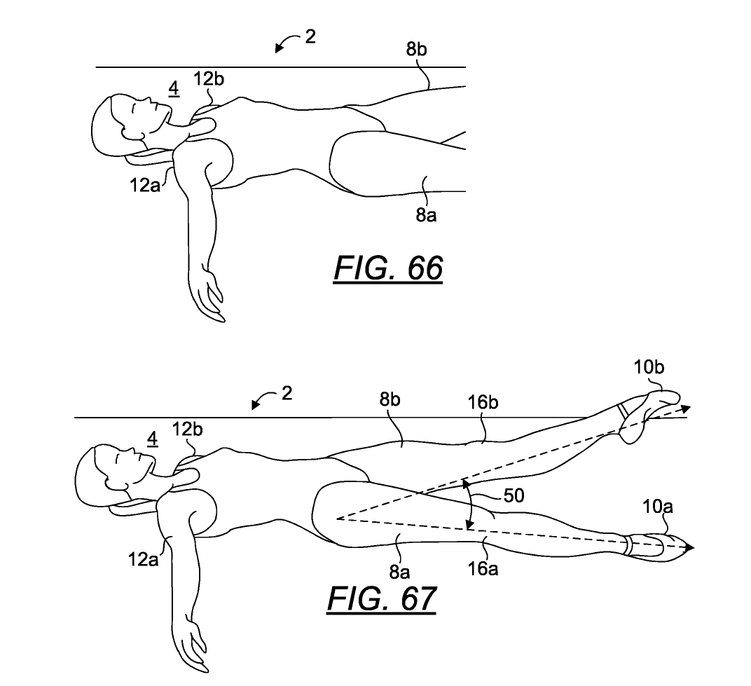

In the fourth advanced stretch protocol depicted in FIGS. 50 and 65-67, the advanced tempo allegretto stretch protocol, the student 2 lies on the floor 4 with the spine 6 straight and the legs 8 extended forward, the feet 10 are pointed in first position, the arms 12 are curved at each respective side and the hands 14 are on the floor 4 facing inwardly toward the body 25 (FIG. 50). The knees 16 and hips 18 are properly aligned and weight is properly distributed. The left foot 10b is flexed and lifted vertically to an angle 50 of not more than 5 degrees with respect to the floor 4 such that the left heel 24b is above the right ankle 30a and the left knee 16b is bent outwardly (FIG. 65). The left foot 10b is pointed and the left leg 8b is straightened and pointed, maintaining this same angle 50 with the right foot 10a pointed forward at full extension (FIG. 67). The left knee 16b is returned to the bent position depicted in FIG. 65 with the left foot 10b resting above the right ankle 30a and this movement is repeated three times for a total of four repetitions. During the course of these repetitions, the right arm 12a is steadily raised to second position (FIG. 66).

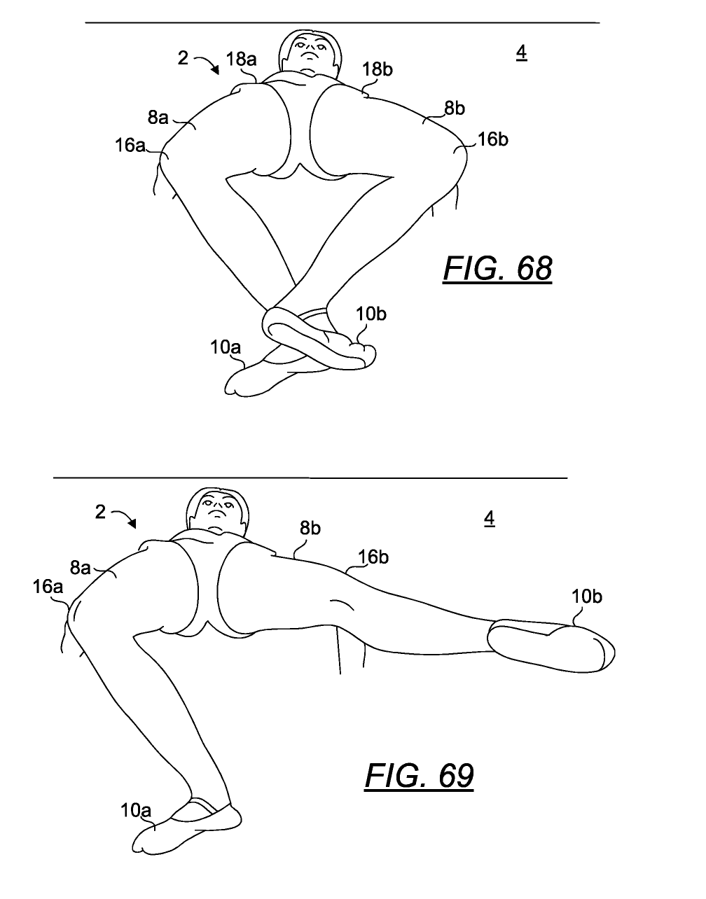

In the next portion of this stretch protocol depicted in FIGS. 50, 52, 65 and 68-69, the student 2 continues in the position depicted and described with referenced to FIG. 65. Then the right leg 8a is bent into a demi-plié position and the hips 18 are raised vertically off the floor 4 such that the body weight is supported on the tops of the shoulders 22 and the right foot 10a (FIG. 68). The left leg 8b is then extended out to the left side and the left foot 10b is pointed (FIG. 69) and this movement is repeated three times for a total of four repetitions. During these repetitions, the right arm 12a is lifted steadily into first position (FIG. 52). The left leg 8b is returned to the position as shown in FIG. 68 and the hips 18 are lowered to the floor, then the left leg 8b and right arm 12a are returned to the floor 4 to resume FIG. 50.

This part of the advanced tempo allegretto stretch protocol depicted in FIGS. 50, 52 and 65-69 is repeated with the right leg 8a for a total of four repetitions.

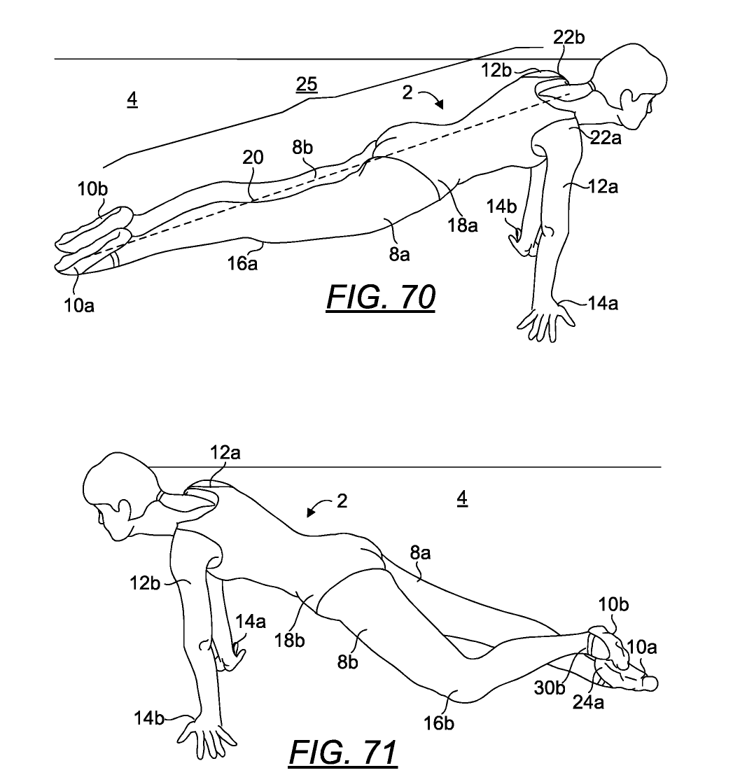

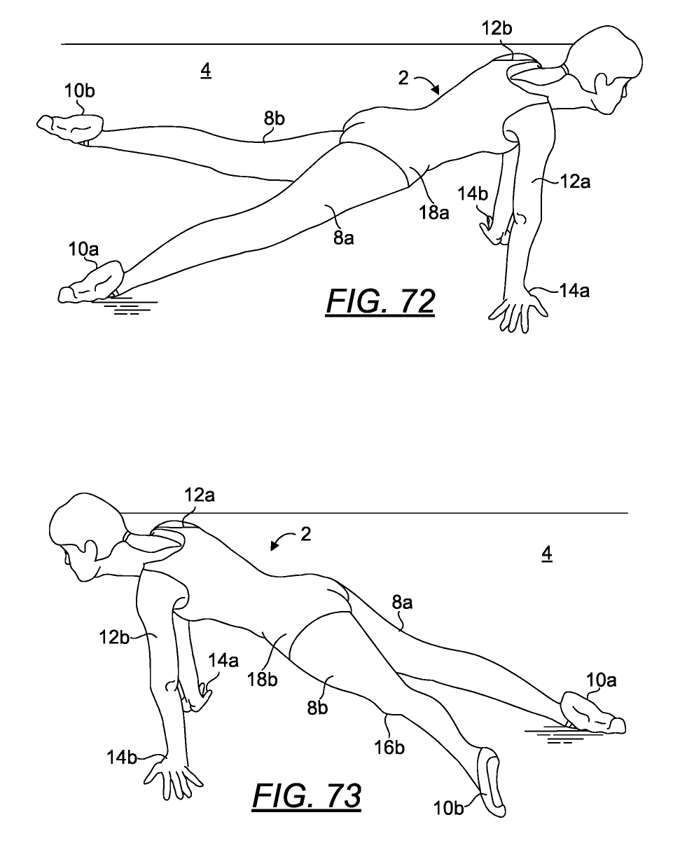

In the next portion of this advanced tempo allegretto stretch protocol depicted in FIGS. 14, 17 and 70-72, the student 2 resumes the position as shown in FIG. 14 by lying on the stomach 34 with the right 10a and left 10b feet extended straight behind and crossing the arms 12 in front while resting the chin 36 or forehead 38 on the hands 14 such that the torso 40 is lifted slightly and the chest 42 is still touching the floor 4. The knees 16, spine 6 and hips 18 are properly aligned and weight is properly distributed. The hands 14 are placed on the floor 4 under the shoulders 22 with the fingers 62 facing outwardly (FIG. 17). The body 25 is lifted vertically off the floor such that the body weight is supported on the hands 14 and the tops of the feet 10 so that the feet 10 to the shoulders 22 form a substantially straight line 20 (FIG. 70). The left leg 8b is lifted, the left foot 10b is flexed and the inside of the left ankle 30b is placed above the bottom of the right heel 24a such that the left knee 16b is slightly bent and facing outwardly (FIG. 71), and then the left leg 8b is extended straight and behind the body 25 with the left knee 16b facing the floor 4 and the left foot 10b is pointed (FIG. 72). The left foot 10b is then flexed and returned to the bottom of the right heel 24a as depicted in FIG. 71 and this movement is repeated three times for a total of four repetitions.

In the next portion of this advanced tempo allegretto stretch protocol depicted in FIGS. 70, 71 and 73, the student 2 continues in the position as depicted and described in FIG. 71. The left leg 8b is extended straight and to the left side of the body 25 while pointing the left foot 10b (FIG. 73) then flexing and returning the left foot 10b above the bottom of the right heel 24a (FIG. 71) and repeating this movement three times for a total of four repetitions. The left foot 10b is then pointed and the left leg 8b is extended straight and lowered to the floor 4 next to the right leg 8a as depicted in FIG. 70.

These steps of the advanced tempo allegretto stretch protocol (FIGS. 14, 17 and 70-73) are then performed with the opposite leg 8a and foot 10a. The floor 4 exercises eliminate the requirement of rotating or changing sides (e.g., from left 10b to right foot 10a on the barre) and provide equilibrium of the body for all movements. Thus, the body is not forced to rebalance and proper posture is achieved without oblique hip 18 extension that tends to accompany the legs 8 on the barre.

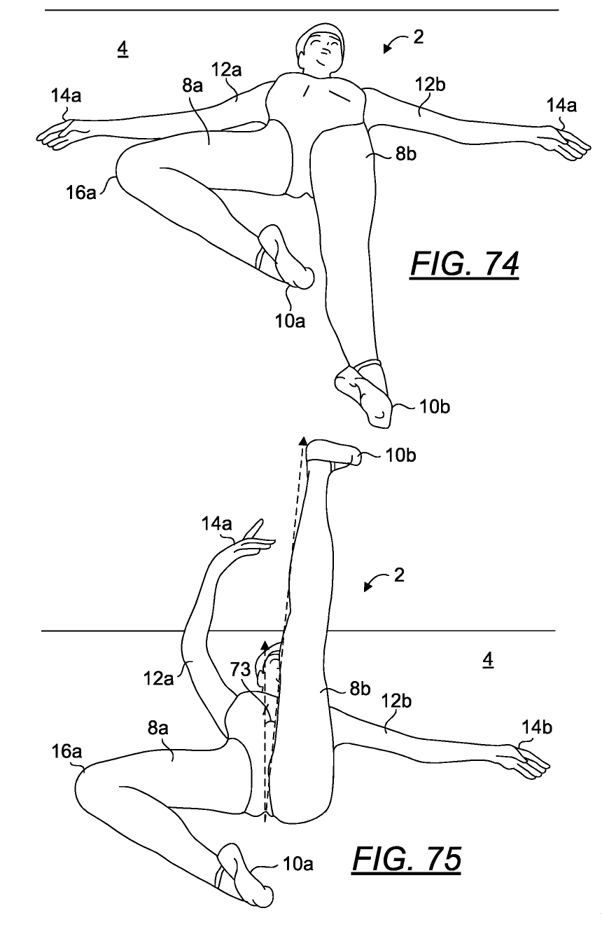

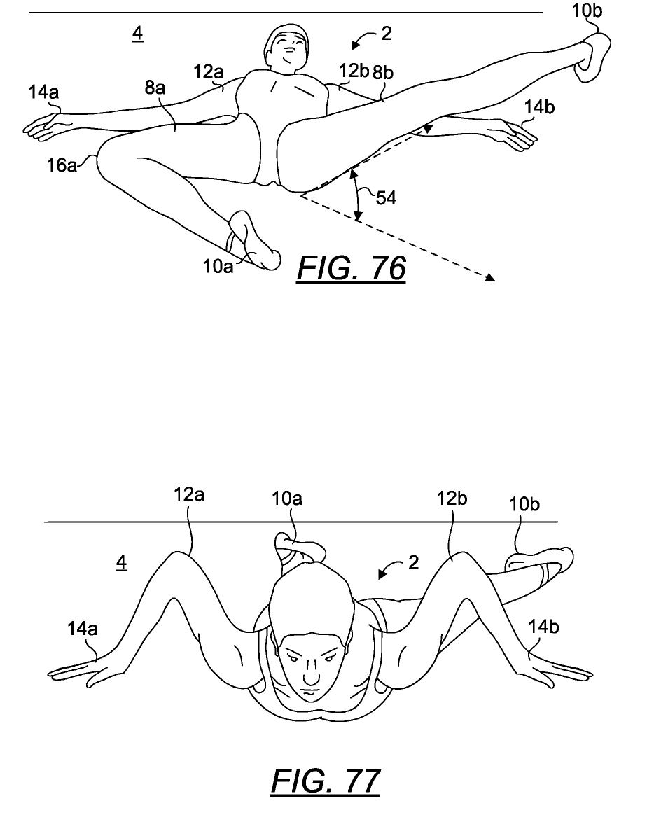

Fifth, the student 2 performs an advanced tempo valse stretch protocol. Reference is made especially to FIGS. 50, 52-53 and 74-76. The student 2 begins in the position depicted and described with reference to FIG. 50. Referring to FIG. 52, the student 2 lifts the arms 12 to first position and then the arms 12 are lowered to second position (FIG. 53). The right leg 8a is bent into a grand plié position with the right knee 16a facing outwardly and resting on the floor 4 (FIG. 74). The left foot 10b is flexed and raised vertically to an angle 73 of no more than about 90 degrees with respect to the torso 40 and the right arm 12a is lifted into first position (FIG. 75). The left leg 8b is lowered to the left side of the body 25 until it is no less than about a 5-degree angle 54 from the floor 4 and the right arm 12a is lowered to second position (FIG. 76). The student then returns to the position as depicted and described with reference to FIG. 75 and then to the position as depicted and described with reference to FIG. 50. This movement is repeated three times for a total of four repetitions.

These steps of the advanced tempo valse stretch protocol (FIGS. 50, 52-53 and 74-76) are then performed with the opposite leg 8a and foot 10a. The floor 4 exercises eliminate the requirement of rotating or changing sides (e.g., from left 10b to right foot 10a on the barre) and provide equilibrium of the body for all movements. Thus, the body 25 is not forced to rebalance and proper posture is achieved without oblique hip 18 extension that tends to accompany the legs 8 on the barre.

In the next portion of this advanced tempo valse stretch protocol depicted in FIGS. 17-18 and 77-78, the student 2, lying on the stomach 34 on the floor 4, raises and extends the left leg 8b to the left side of the body 25 and lowers the left leg 8b to the floor 4 such that the legs 8 are spread wide apart (FIG. 77). The student 2 then raises the body 25 off the floor 4 such that the body weight is supported on the hands 14 and the tops of the feet 10 and the feet 10 to the shoulders 22 form a substantially straight line. The body 25 is then lowered to the floor 4 and the left leg 8b is lifted and then lowered to the floor 4 next to the right leg 8a. The student 2 then lifts the torso 40 slowly until the arms 12 are extended straight (FIG. 18) and then the torso 40 is lowered slowly to the floor 4 to resume the position depicted and described with reference to FIG. 17. This movement is repeated one time for a total of two repetitions.

These steps of the advanced tempo valse stretch protocol (FIGS. 17-18 and 77-78) are then performed with the opposite leg 8a and foot 10a. The floor 4 exercises eliminate the requirement of rotating or changing sides (e.g., from left 10b to right foot 10a on the barre) and provide equilibrium of the body for all movements. Thus, the body 25 is not forced to rebalance and proper posture is achieved without oblique hip 18 extension that tends to accompany the legs 8 on the barre.

Sixth, the student 2 performs an advanced tempo sostedendo stretch protocol. Reference is made especially to FIGS. 5, 31-34 and 45a. The student 2 sits on the floor 4 such that the spine 6 is straight and the legs 8 are extended forwardly and spread wide apart from one another, the feet 10 are pointed, and the arms 12 are straight next to the hips 18 at each respective side (FIG. 5). The hips 18 (pelvis) are lifted vertically off the floor 4 so that the body weight is supported evenly on the fingers 62 and the heels 24 of the feet 10 (FIG. 31). The knees, spine 6 and hips are properly aligned and weight is properly distributed. The hips 18 are then slowly lowered to the floor 4.

Returning to the position depicted and described with respect to FIG. 5, the arms 12 are moved into the second position (FIG. 32) and then into fifth position above the head 37 but slightly forward of the torso 40 (FIG. 79) then into first position (FIG. 45a) and then the arms 12 are lowered to the floor 4 in front of the body 25 with the hands 14 flat on the floor 4, one stacked on the other. The hips 18 are lifted vertically off the floor 4 while shifting the torso 40 forward and keeping the spine 6 straight (FIG. 34). The hips 18 are lowered to the floor 4 slowly. The arms 12 are moved into fifth position (FIG. 33), then into second position (FIG. 32).

This part of the advanced tempo sostenendo stretch protocol (depicted in FIGS. 5, 31-34 and 45a) is then performed a second time.

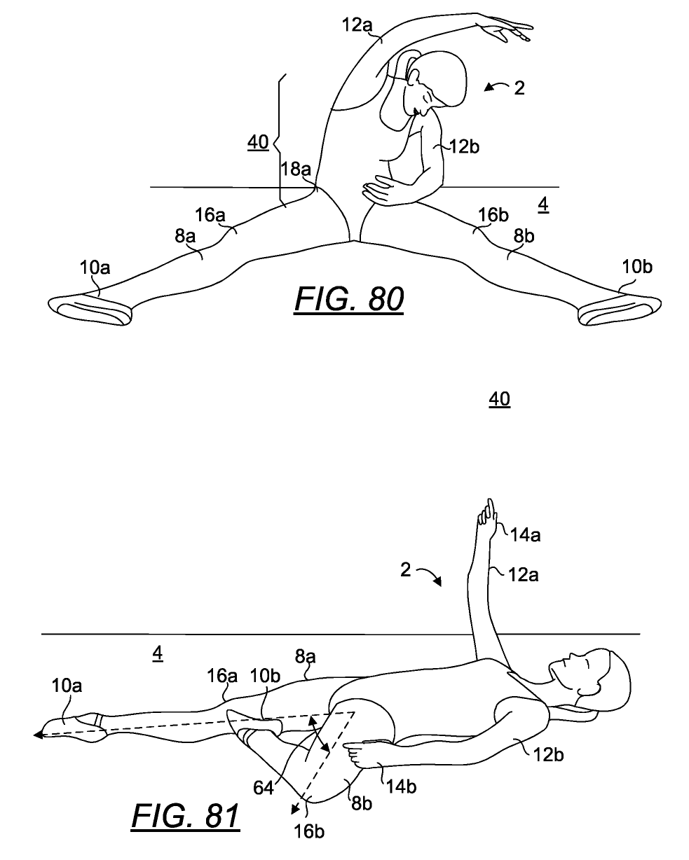

This next part of the advanced tempo sostenendo stretch protocol is depicted in FIGS. 32, 79 and 80. Returning to the position depicted and described with respect to FIG. 32, such that the student 2 is sitting on the floor 4 such that the spine 6 is straight and the legs 8 are extended forwardly and spread wide apart from one another, the feet 10 are pointed, the arms 12 in a second position, fingers 62 resting lightly on the floor 4, the left arm 12b is moved into the first position and the right arm 12a is lifted into the fifth position (FIG. 79). The torso 40 is bent sideways from the hip 18 towards the left knee 16b, keeping the right hip 18a firmly on the floor 4 while maintaining a straight spine 6 and the right arm 12a is extended straight and parallel to the left leg 8b as depicted in FIG. 80. The torso 40 is raised so that the spine 6 is extended straight and vertical with the left arm 12b in first position and the right arm 12a in fifth position (FIG. 79). This sequence depicted in FIGS. 32, 79 and 80 is repeated one time before repeating twice with the opposite leg 8 and arms 12 such that there are two repetitions on each side of the body 25.

Seventh, the student 2 performs an advanced tempo adagio stretch protocol as depicted in FIGS. 50, 41 and 81. Referring to FIG. 50, the student 2 lies on the floor 4 with the spine 6 straight and the legs 8 extended forward, the feet 10 are pointed in first position, the arms 12 are curved at each respective side and the hands 14 are on the floor 4 facing inwardly toward the body 25. The left leg 8b is bent until the left foot 10b is angled at the hollow of the right knee 16a and the left knee 16b is angled at about 45 degrees 64 with respect to the right leg 8a and the right arm 12a is lifted to first position (FIG. 81). The left leg 8b is extended straight and is lifted vertically until it is disposed at an angle 66 from about 60 degrees to about 90 degrees with respect to the torso 40 and the right arm 12a is lowered to second position (FIG. 41). The left leg 8b is lowered and bent until the left foot 10b is resting at the hollow of the right knee 16a and the right arm 12a is lifted to first position (FIG. 81) and then returns to the position as shown in FIG. 50 with both legs 8 extended straight outward and the arms 12 curved at each respective side. This sequence depicted in FIGS. 50, 41 and 81 is repeated one time for a total of two repetitions

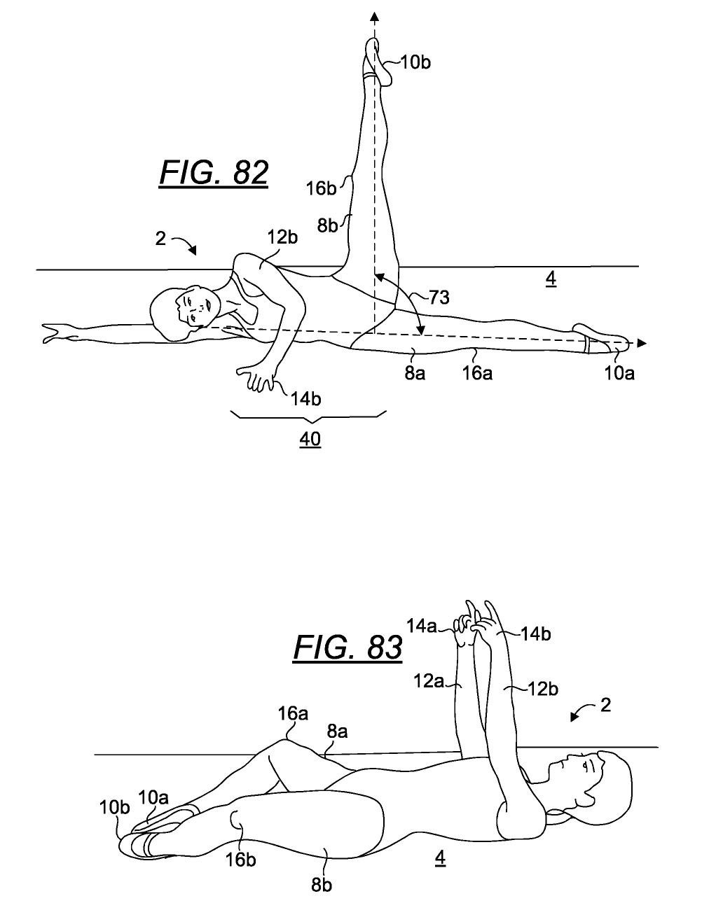

In the next part of this advanced tempo adagio stretch protocol depicted in FIGS. 62, 64 and 82, the student 2 switches positions to lie on the right side of the body 25 on the floor 4 such that the right arm 12a is extended straight above with the head 43 resting on the right arm 12a and the left hand 14b resting on the floor 4 in front of the torso 40, the left hip 18b and left leg 8b stacked on top of the right hip 18a and right leg 8a and the feet 10 pointed in first position (FIG. 62). The left leg 8b is bent such that the left foot 10b is resting at the hollow of the right knee 16a and the left knee 16b is at an angle 64 of about 45 degrees with respect to the right leg 8a (FIG. 64). The left leg 8b is extended straight and raised vertical to an angle 73 of about 60 degrees to 90 degrees with respect to the torso 40 (FIG. 82) and then the left leg 8b is bent and lowered again as depicted and described with respect to FIG. 64 with the left leg 8b bent such that the left foot 10b is resting at the hollow of the right knee 16a, and finally the left leg 8b is extended straight and parallel to the right leg 8a as depicted and described in FIG. 62. This sequence depicted in FIGS. 62, 64 and 82 is repeated one time for a total of two repetitions.

These steps of the advanced tempo adagio stretch protocol (depicted in FIGS. 41, 50, 62, 64, 81 and 82) are then performed on the opposite side of the body 25.

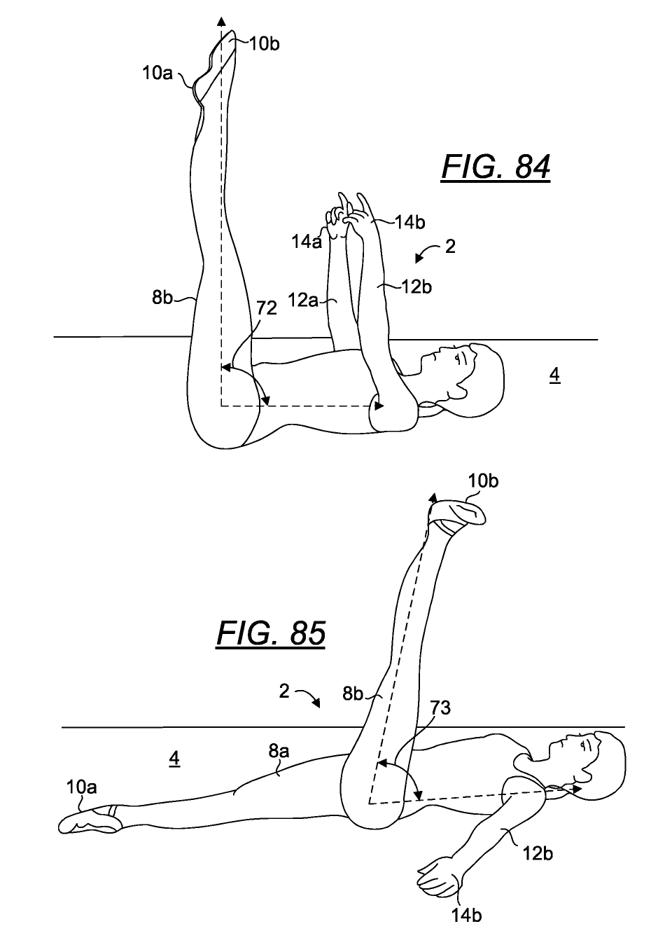

In the next part of this advanced tempo adagio stretch protocol depicted in FIGS. 50, 51, 53, 83 and 84, the student 2 switches positions to lie on the back 6 on the floor 4 with the spine 6 straight and the legs 8 extended forward, the feet 10 are pointed in first position, the arms 12 are curved at each respective side and the hands 14 are on the floor 4 facing inwardly toward the body 25 (FIG. 50). The legs 8 are bent into the grand plié position and the arms 12 are raised into the first position (FIG. 83). The pelvis 68 is lifted vertically off the floor and the legs 8 are extended vertically until they are at an angle 72 of no more than about 90 degrees with respect to the torso 40 (FIG. 84). The feet 10 are then flexed in first position and the legs 8 are lowered to the floor 4 simultaneously (FIG. 51) while the arms 12 are lowered into the second position (FIG. 53). This movement is repeated three times for a total of four repetitions.

In the next part of this advanced tempo adagio stretch protocol depicted in FIGS. 45, 50, 51, 53 and 83, the student 2 is lying on the back 6 on the floor 4 with the legs 8 extended straight forward, the feet 10 flexed in the first position (FIG. 51) and the arms 12 resting on the floor 4 in the second position (FIG. 53). The legs 8 are bent into the grand plié position and the arms are raised into the first position (FIG. 83). The pelvis 68 is lifted vertically in the grand plié position, and this position is held for about one minute (FIG. 45). Then the student 2 resumes the position depicted in FIG. 83 with the pelvis 68 lowered to the floor 4. The legs 8 are extended straight forward and the arms 12 are lowered to the floor as depicted and described with respect to FIG. 50.

The eighth and final advanced stretch protocol is the advanced tempo allegretto stretch protocol depicted in FIGS. 14, 15, 50, 52, 53, 62, 85 and 86. The student 2 resumes the position as shown in FIG. 50 in which the student 2 lies on the back 6 on the floor 4 with the spine 6 straight and the legs 8 extended forward, the feet 10 are pointed in first position, the arms 12 are curved at each respective side and the hands 14 are on the floor 4 facing inwardly toward the body 25. The arms 12 are lifted into the first position (FIG. 52) and then lowered into the second position (FIG. 53). The left foot 10b is flexed and the left leg 8b is lifted swiftly at an angle 73 of no more than about 90 degrees with respect to the torso 40 (FIG. 85). Then the left foot 10b is pointed and slowly lowered to the floor 4. This movement is repeated three times for a total of four repetitions.

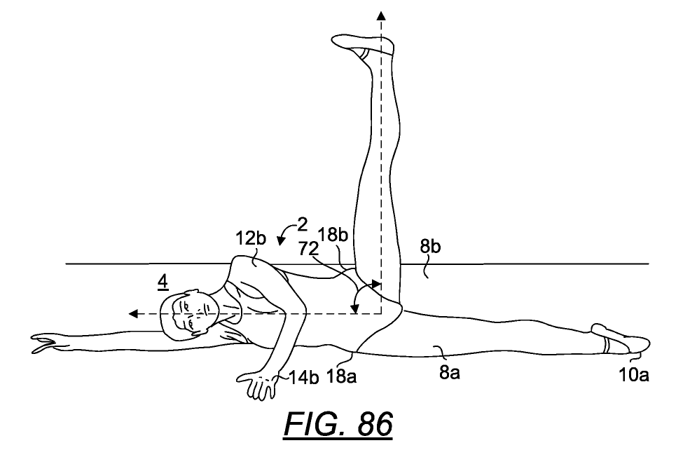

Next, the student 2 switches positions to lie on the right side of the body 25 on the floor 4 such that the right arm 12a is extended straight above with the head 43 resting on the right arm 12a and the left hand 14b resting on the floor 4 in front of the torso 40, the left hip 18b and left leg 8b stacked on top of the right hip 18a and right leg 8a and the feet 10 pointed in the first position (FIG. 62). The left foot 10b is flexed and the left leg 8b is lifted swiftly to an angle 72 of no more than about 90 degrees with respect to the torso 40 (FIG. 86) then the left foot 10b is pointed and the left leg 8b is lowered on to the right leg 8a (FIG. 62). This movement is repeated three times for a total of four repetitions.

The student 2 then switches positions to lie on the stomach 34 (on the floor 4) with the legs 8 extended straight back, the feet 10 pointed and the arms 12 crossed in front with the forehead 38 or chin 36 resting on the arms 12 (FIG. 14). The left foot 10b is flexed and the left leg 8b is lifted straight up quickly (FIG. 15). Then the left foot 10b is pointed and lowered slowly. This movement sequence is repeated three times for a total of four repetitions.

Next, the student 2 repeats the sequence on the right side of the body 25 by lying on the floor 4 on the right side of the body 25 such that the right arm 12a is extended straight above with the head 43 resting on the right arm 12a and the left hand 14b resting on the floor 4 in front of the torso 40, the left hip 18b and left leg 8b stacked on top of the right hip 18a and right leg 8a and the feet 10 pointed in the first position (FIG. 62). The left foot 10b is flexed and the left leg 8b is lifted swiftly to an angle 72 of no more than about 90 degrees with respect to the torso 40 (FIG. 86) then the left foot 10b is pointed and the left leg 8b is lowered on to the right leg 8a (FIG. 62). This movement is repeated three times for a total of four repetitions.

This sequence depicted in FIGS. 14, 15, 50, 52, 53, 62, 85 and 86 is repeated with the right leg 8a.

In the next portion of this protocol, the student 2 sits on the floor 4 such that the spine 6 is straight, the legs 8 are bent, the feet 10 are pointed, and the bottoms of the feet 10 are facing inwardly and the toes are touching (FIG. 47). The student 2 grasps the bottom of the left heel 24b with the left hand 14b and the bottom of the right heel 24a with the right hand 14a such that the arms 12 are extended straight and the inside of the elbow 74 is facing outwardly (FIG. 47). The left leg 8b is lifted so that the leg 8b is extended at about a 45 degree angle 76 with respect to the torso while keeping the spine 6 straight (FIG. 48) and the left foot 10b pointed. This position is held for at least six seconds. Then the left leg 8b is bent in at the knee 16b and returned to the position depicted in FIG. 47 where the toes are touching the floor. This movement sequence is repeated one time with the right leg 8a. Then, both legs 8 are lifted simultaneously such that the legs 8 are extended straight and spread wide apart from one another keeping the spine 6 straight and the feet 10 pointed. This position is held for at least six seconds. Then the legs 8 are bent and lowered to the floor 4 and the hands 14 are released from the feet 10.

1. A method of training a human body to perform ballet movements by warming up the muscles, the human body having a torso with a back with a spine; a right and left leg each having a knee and a foot with toes, an ankle and a heel; a right and left arm each having a shoulder, an elbow and a hand with a palm and fingers; a pelvis; a left side and a right side each having a hip; the method consisting essentially of performing a series of stretching protocols on a floor in a predetermined series and number of repetitions by performing a tempo adagio stretch protocol comprising
sitting on the floor such that the spine is straight and the legs are extended forward, the feet are pointed in a first position, the arms are straight at each respective side and the hands are on the floor facing outwardly in a relaxed manner such that weight is not born on the hands;
flexing the feet in the first position and returning the feet to the pointed position four times;
bending the legs into a demi-plié position with the feet flexed and returning the legs to the forward extended position with pointed feet four times;
flexing the feet in the first position and returning the feet four times; and
lifting the hips off the floor to form a substantially straight line from the shoulders to the pointed feet while supporting the hands and feet in the first position, then lowering the hips to the floor and repeating three times.

2. The method of training the human body to perform ballet movements of claim 1, further comprising a step of performing a demi-plié in écarté stretch protocol comprising
sitting on the floor such that the spine is straight and the legs are extended forward and spread wide apart from one another, the feet are pointed in a second position, the arms are straight at each respective side and the hands are on the floor facing outwardly in a relaxed manner such that weight is not born on the hands;
flexing the feet in the second position and returning the feet to the pointed position four times;
bending the legs into the demi-plié position with the feet flexed and returning four times;
flexing the feet in the second position and returning to the pointed position four times; and
raising the hips vertically off the floor so that the weight is supported by the hands and heels, feet pointed, then lowering the hips to the floor and repeating three times.

3. The method of training the human body to perform ballet movements of claim 2, further comprising a step of performing a second tempo adagio stretch protocol and then a step of performing a second demi-plié in écarté stretch protocol.

4. The method of training the human body to perform ballet movements of claim 3, the human body further having a pelvis; a torso having a stomach, a chest, and an upper body; and a head with a chin and a forehead; the method further comprising a step of performing a tempo allegretto stretch protocol comprising
sitting on the floor such that the spine is straight and the legs are extended forward, the feet are pointed in the first position, the arms are straight at each respective side and the hands are on the floor facing outwardly in a relaxed manner such that weight is not born on the hands;
lifting the left leg up to an angle of 20 degrees with respect to the floor and flexing the left foot while maintaining the right leg straight and on the floor with the right foot pointed;
lowering the left leg, foot pointed, to the floor and repeating three times;
flexing the left foot and moving the left leg out to the left side slightly at about a 45-degree angle with respect to the right leg that is straight and on the floor with the right foot pointed;
pointing the left foot and returning the left leg parallel and adjacent to the right leg and repeating three times;
bending the left leg slightly so that the left foot touches the inside of the right ankle and the toes of the left foot are pointed while maintaining the right leg straight and on the floor with the right foot in the first position and toes pointed;
returning the left leg parallel and adjacent to the right leg and repeating three times;
sitting on the floor such that the spine is straight, both legs are extended forward, the feet are pointed in the first position, the arms are straight at each respective side and the hands are on the floor facing outwardly in a relaxed manner such that weight is not born on the hands;
moving the left foot up the right leg to a hollow of the right knee, with the left knee extended outwardly;
returning the left leg to full extension;
moving the left foot up the right leg to the hollow of the right knee and raising the left knee so that the left leg remains bent and facing forward, the toes of the left foot touching the floor;
returning the left leg to full extension and repeating the sequence once;
sitting on the floor such that the spine is straight and the legs are extended forward, the feet are pointed, the arms are straight at each respective side and the hands are on the floor facing outwardly in a relaxed manner such that weight is not born on the hands;
lifting the right leg, foot pointed, up to an angle of 20 degrees from the floor while maintaining the left leg, foot pointed, straight and on the floor;
lowering the right leg, foot pointed, to the floor and repeating three times;
flexing the right foot and moving the right leg out to the right side slightly at about a 45-degree angle with respect to the left leg that is straight and on the floor with the left foot pointed;
pointing the right foot and returning the right leg parallel and adjacent to the left leg and repeating three times;
bending the right leg slightly so that the right foot touches the inside of the left ankle and the toes of the right foot are pointed while maintaining the left leg straight and on the floor with the left foot in the first position and toes pointed;
returning the right leg parallel and adjacent to the left leg and repeating three times;
sitting on the floor such that the spine is straight, both legs are extended forward, the feet are pointed in the first position, the arms are straight at each respective side and the hands are on the floor facing outwardly in a relaxed manner such that weight is not born on the hands;
moving the right foot up the left leg to a hollow of the left knee, with the right knee extended outwardly;
returning the right leg to full extension;
moving the right foot up the left leg to the hollow of the left knee and raising the right knee so that the right leg remains bent and facing forward, the toes of the right foot touching the floor;
returning the right leg to full extension and repeating the sequence once;
lying on the stomach while extending the right and left legs straight behind and crossing the arms in front while resting the chin or forehead on the hands such that the torso is lifted slightly and the chest is still touching the floor;
flexing the left foot and lifting the left leg straight up to an angle of not more than 20 degrees with respect to the floor while maintaining the right leg straight and on the floor;
pointing the left foot and returning the left leg to the floor and repeating three times;
lying on the stomach while extending the right and left legs straight behind and crossing the arms in front while resting the chin or forehead on the hands such that the torso is lifted slightly and the chest is still touching the floor;
extending the left leg to the left side at a substantially 45-degree angle while the left foot is pointed and turned outwardly such that the inside of the left leg is pressing into the floor;
returning the left leg parallel and adjacent to the right leg and repeating three times;
lying on the stomach while extending the right and left legs straight behind and crossing the arms in front while resting the chin or forehead on the hands such that the torso is lifted slightly and the chest is still touching the floor;
flexing the right foot and lifting the right leg straight up to an angle of not more than 20 degrees with respect to the floor while maintaining the left leg straight and on the floor;
pointing the right foot and returning the right leg to the floor and repeating three times;
lying on the stomach while extending the right and left feet straight behind and crossing the arms in front while resting the chin or forehead on the hands such that the torso is lifted slightly and the chest is still touching the floor;
extending the right leg to the right side at a substantially 45-degree angle while the right foot is pointed and turned outwardly such that the inside of the right leg is pressing into the floor;
returning the right leg parallel and adjacent to the left leg and repeating three times;
lying on the stomach while extending the right and left feet straight behind, the forehead facing forward with the chin resting on the floor, and the arms in a second position with the hands pointed outwardly and the arms bent;
lifting the torso slowly until the arms are extended straight; and
lowering the torso and repeating three times.

5. The method of training the human body to perform ballet movements of claim 4, further comprising a step of performing a tempo allegretto stretch protocol comprising
sitting on a floor such that the spine is straight and the legs are extended forward, the feet are pointed in the first position, the arms are straight at each respective side and the hands are on the floor facing outwardly in a relaxed manner such that weight is not born on the hands;
flexing and lifting the left foot up to an angle of not more than 5 degrees with respect to the floor such that the left heel is above the right ankle and the left knee is bent outwardly;
pointing the left foot and straightening the left leg at the same angle with the right foot pointed and forward at full extension;
returning the left knee back to the bent position with the left foot flexed and resting above the right ankle and repeating three times;
sitting on the floor such that the spine is straight and the legs are extended forward, the feet are pointed in the first position, the arms are straight at each respective side and the hands are on the floor facing outwardly in a relaxed manner such that weight is not born on the hands;
lifting the left foot up to an angle of not more than 5 degrees with respect to the floor such that the left heel is above the right ankle and the left knee is bent outwardly;
extending the left leg out to the side slightly at about a 20-degree angle with respect to the right leg;
returning the left leg to the bent position with the left foot resting above the right ankle and repeating three times;
sitting on the floor such that the spine is straight and the legs are extended forward, the feet are pointed in the first position, the arms are straight at each respective side and the hands are on the floor facing outwardly in a relaxed manner such that weight is not born on the hands;
flexing and lifting the right foot up to an angle of not more than 5 degrees with respect to the floor such that the right heel is above the left ankle and the right knee is bent outwardly;
pointing the right foot and straightening the right leg at the same angle with the foot pointed at full extension;
flexing the right foot and returning the right knee back to the bent position with the right foot resting above the left ankle and repeating three times;
sitting on the floor such that the spine is straight and the legs are extended forward, the feet are pointed in the first position, the arms are straight at each respective side and the hands are on the floor facing outwardly in a relaxed manner such that weight is not born on the hands;
lifting the right foot up to an angle of not more than 5 degrees with respect to the floor such that the right heel is above the left ankle and the right knee is bent outwardly;
extending the right leg out to the side slightly at about a 20-degree angle with respect to the left leg;
returning the right leg to the bent position with the right foot resting above the left ankle and repeating three times;
sitting on the floor such that the spine is straight, the arms are straight at each respective side and the hands are on the floor facing outwardly in a relaxed manner such that weight is not born on the hands, the legs are bent into the demi-plié position and the feet are flexed;
lifting the left foot up to an angle of not more than 5 degrees with respect to the floor such that the left heel is above the right ankle;
lifting the hips off the floor while supporting the body weight on the hands and right foot;
straightening the left leg at full extension at about a 45-degree angle with respect to the right leg and pointing the left foot;
bending the left leg such that the left foot rests above the right ankle while keeping the hips raised;
repeating the left leg extension and bend three times while keeping the hips raised;
lowering the hips to the floor;
sitting on the floor such that the spine is straight, the arms are straight at each respective side and the hands are on the floor facing outwardly in a relaxed manner such that weight is not born on the hands, the legs are bent into the demi-plié position and the feet are flexed;
lifting the right foot up to an angle of not more than 5 degrees with respect to the floor such that the right heel is above the left ankle;
lifting the hips off the floor while supporting the body weight on the hands and left foot;
straightening the right leg at full extension at about a 45-degree angle with respect to the left leg and pointing the right foot;
bending the right leg such that the right foot rests above the left ankle while keeping the hips raised;
repeating the right leg extension and bend three times while keeping the hips raised; and
lowering the hips to the floor.

6. The method of training the human body to perform ballet movements of claim 5, further comprising a step of performing a tempo valse stretch protocol comprising
lying on the back on the floor such that the spine is straight and the legs are extended, feet pointed in the first position, the arms in the second position;
bending the right leg into passé position en dehors, with the right foot flexed and angled at the hollow of the left knee;
lifting the fully-extended left leg upwardly while flexing the left foot;
lowering the left leg out to the left side slightly at about a 20-degree angle with respect to the floor while keeping the right hip on the floor;
lifting the left leg upwardly;
lowering the left leg to the floor, pointing the foot and repeating three times.
lying on the back on the floor such that the spine is straight and the legs are extended, the feet pointed in the first position, the arms in the second position;
bending the left leg into passé position en dehors, with the left foot flexed and angled at the hollow of the right knee;
lifting the fully-extended right leg upwardly while flexing the right foot;
lowering the right leg out to the side slightly at about a 20-degree angle with respect to the floor while keeping the left hip on the floor;
lifting the right leg upwardly;
lowering the right leg to the floor, pointing the foot and repeating three times;
lying on the floor on the stomach with the right and left legs extended straight behind, the feet pointed, the arms in the second position with the hands pointed outwardly and the arms bent and the forehead facing forward,
extending the left leg at a 25-degree angle with respect to the right leg while externally rotating and flexing the left foot such that the inside of the left foot is pressing into the floor and the arms are in the second position with the fingers pointed outwardly and the arms bent;
lifting the entire body off the floor so that the weight is supported on the hands and feet, forming a substantially straight line from the head to the feet and holding for one minute;
lowering the body to the floor slowly;
returning the left leg next to the right leg while pointing the feet straight back;
lifting the torso slowly until the arms are extended straight and holding for one minute;
lowering the torso and repeating the entire sequence three times;
lying on the floor on the stomach with the right and left legs extended straight behind, the feet pointed, the arms in the second position with the hands pointed outwardly and the arms bent and the forehead facing forward;
extending the right leg at a 25-degree angle with respect to the left leg while externally rotating and flexing the right foot such that the inside of the right foot is pressing into the floor and the arms are in the second position with the fingers pointed outwardly and the arms are bent;
lifting the entire body off the floor so that the weight is supported on the hands and feet, forming a substantially straight line from the head to the feet and holding for one minute;
lowering the body to the floor slowly;
returning the right leg next the left leg while pointing the feet straight back;
lifting the torso slowly until the arms are extended straight and holding for one minute; and
lowering the torso and repeating the entire sequence three times.

7. The method of training the human body to perform ballet movements of claim 6, further comprising a step of performing a tempo sostendendo stretch protocol comprising
sitting on the floor such that the spine is straight and the legs are extended forward and spread wide apart from one another, the feet are pointed, the arms are straight next to the hips at each respective side, only the fingers of each hand touching the floor;
lifting the hips vertically off the floor so that the weight is supported evenly on the fingers and thumb and the heels of the feet,
lowering the hips to the floor slowly;
sitting on the floor such that the spine is straight and the legs are extended outwardly and spread wide apart from one another, the feet are pointed, the arms are straight at each respective side, only the fingers of each hand touching the floor;
moving the arms into the second position;
moving the arms into a fifth position above the head but slightly forward of the body;
placing the palms flat on the floor, one stacked on the other, in front of the body;
lifting the hips vertically off the floor while shifting the torso forward and keeping the spine straight;
lowering the hips to the floor slowly;
moving the arms into the fifth position above the head;
moving the arms into the second position;
sitting on the floor such that the spine is straight and the legs are extended forward and spread wide apart from one another, the feet are pointed, the arms are straight at each respective side, only the fingers of each hand touching the floor;
performing a second tempo sostendendo stretch protocol;
sitting on the floor such that the spine is straight and the legs are extended forward and spread wide apart from one another, the feet are pointed, the arms in the second position;
bending the left leg inward at the knee into the demi-plié position;
lifting the left arm into a first position and lifting the right arm into the fifth position;
bending the torso sideways from the hip towards the left knee, keeping the right hip firmly on the floor while maintaining a straight spine;
lowering the arms simultaneously into the second position;
raising the torso so that the spine is extended straight and vertical;
repeating one time;
sitting on the floor such that the spine is straight and the legs are extended forward and spread wide apart from one another, the feet are pointed, the arms are in the second position;
bending the right leg inward at the knee into the demi-plié position;
lifting the right arm into the first position and lifting the left arm into the fifth position;
bending the torso sideways from the hip towards the right knee, keeping the left hip firmly on the floor while maintaining a straight spine;
lowering the arms simultaneously into the second position;
raising the torso so that the spine is extended straight and vertical; and
repeating one time.

8. The method of training the human body to perform ballet movements of claim 7, further comprising a step of performing a tempo adagio stretch protocol comprising
lying on the back on the floor such that the spine is straight and the legs are extended, feet pointed in the first position, the arms in the second position and the palms of the hands are facing the feet;
bending the left leg until the left foot (pointed) is angled at the hollow of the right knee and the left knee angled at about 45 degrees from the right leg, which remains extended and the right foot pointed;
extending the left leg straight and raising the left leg vertically until it is disposed from about 60 degrees to about 90 degrees with respect to the torso;
lowering the left leg and bending the left leg until the left foot is resting at the hollow of the right knee;
extending the left leg straight and parallel to the right leg;
repeating one time;
lying on the back on the floor such that the spine is straight and the legs are extended, feet pointed in the first position, the arms in the second position and the palms of the hands are facing the feet;
bending the right leg until the right foot (pointed) is angled at the hollow of the left knee and the right knee angled at about 45 degrees from the left leg, which remains extended, the left foot pointed;
extending the right leg straight and raising the right leg vertically until it is disposed from about 60 degrees to about 90 degrees with respect to the torso;
lowering the right leg and bending the right leg until the right foot is resting at the hollow of the left knee;
extending the right leg straight and parallel to the left leg;
repeating one time;
lying on the back such that the spine is straight and the legs are extended, the feet are pointed, the arms in the second position and the palms of the hands are facing the feet;
bending the legs into a grand plié while pointing the feet;
extending both legs simultaneously at an angle of no more than about 45 degrees with respect to the floor, then raising the legs simultaneously until they are at an angle of no more than about 90 degrees with respect to the torso;
lowering the legs to the floor simultaneously and bending the legs into the grand plié;
extending the legs straight with the feet pointed;
lying on the floor such that the legs are extended outwardly, the feet are pointed and the arms are disposed in the second position;
bending the legs into the grand plié while pointing the feet;
lifting the pelvis in the grand plié position while simultaneously moving the arms into the first position and holding for one minute; and
lowering the pelvis and repeating three times.

9. The method of training the human body to perform ballet movements of claim 8, further comprising a step of performing an allegretto stretch protocol comprising
Lying on the back on the back such that the spine is straight and the legs are extended, the feet pointed in the first position, the arms in the second position and the palms of the hands are facing the feet;
flexing the left foot and lifting the left leg swiftly at an angle no more than about 90 degrees with respect to the torso;
pointing the left foot and lowering the left leg slowly to the floor;
repeating three times;
lying on the back on the floor such that the spine is straight and the legs are extended, the feet pointed in the first position, the arms in the second position and the palms of the hands are facing the feet;
flexing the right foot and lifting the right leg swiftly at an angle no more than about 90 degrees with respect to the torso;
pointing the right foot and lowering the right leg slowly to the floor;
repeating three times;
lying on the stomach on the floor such that the legs are extended straight back, the feet are pointed and the arms are crossed in front of the body with the head resting on the arms;
flexing the left foot and lifting the left leg quickly, maintaining full extension of the leg;
pointing the left foot and lowering the left leg slowly;
repeating three times;
lying on the stomach on the floor such that the legs are extended straight back, the feet are pointed and the arms are crossed in front of the body with the head resting on the arms;
flexing the right foot and lifting the right leg quickly, maintaining full extension of the leg;
pointing the right foot and lowering the right leg slowly;
repeating three times;
sitting on the floor such that the spine is straight, the legs are bent, the feet are pointed, the bottoms of the feet are facing inward and the toes are touching;
grasping the bottom of the left heel with the left hand and the bottom of the right heel with the right hand such that the arms are extended straight and the inside of each elbow is facing outwardly;
lifting the left leg so that it is extended straight at about a 45-degree angle with respect to the torso while keeping the spine straight and the left foot pointed;
holding this position for at least six seconds;
bending the left leg in at the knee until the toes are touching the floor;
lifting the right leg so that it is extended straight at about a 45-degree angle with respect to the torso while keeping the spine straight and the left foot pointed;
holding this position for at least six seconds;
bending the right leg in at the knee until the toes are touching the floor;
lifting both legs simultaneously such that the legs are extended straight and spread wide apart from one another, keeping the spine straight and the feet pointed;
holding this position for at least six seconds; and
bending and lowering the legs slowly to the floor and releasing the hands form the back of the heels.

10. A method of training a human body to perform ballet movements by warming up the muscles, the human body having a back with a spine; a right and left leg each having a knee and a foot with toes, an ankle and a heel; a right and left arm each having a shoulder, an elbow and a hand with fingers; a left side and a right side each having a hip; the method consisting essentially of performing a series of stretching protocols on a floor in a predetermined series and number of repetitions by performing a tempo adagio stretch protocol comprising:
lying on the back on the floor such that the spine is straight and the legs are extended, feet pointed in a first position, the hands on the floor and arms curved at each respective side with the palms of the hands facing inwardly toward the body;
flexing the feet in the first position then pointing the feet in the first position for a total of four repetitions while simultaneously moving the arms steadily into a first position one time;
bending the legs into a demi-plié position with the feet flexed then extending the legs, feet pointed, for a total of four repetitions while simultaneously moving the arms steadily from first into a second position one time;
flexing the feet in the first position then pointing the feet in the first position for a total of four repetitions while simultaneously moving the arms steadily from second into the first position one time; and
raising the hips vertically off the floor to form a substantially straight line from the shoulders to the pointed feet while supporting the body weight on the shoulders and the feet then lowering the hips to the floor and repeating for a total of four repetitions while simultaneously lowering the arms near the sides of the body.

11. The method of training the human body to perform ballet movements of claim 10, further comprising a step of performing a demi-plié in écarté stretch protocol comprising:
lying on the back on the floor such that the spine is straight and the legs are extended and spread wide apart from one another, feet pointed in a second position, the arms curved at each respective side with the palms of the hands facing inwardly towards the body;
flexing the feet in the second position then pointing the feet in the second position for a total of four repetitions while simultaneously moving the arms steadily into the first position one time;
bending the legs into the demi-plié position with the feet flexed then extending the legs, feet pointed, for a total of four repetitions while moving the arms steadily into the second position one time, flexing the feet in the second position then pointing the feet in the second position for a total of four repetitions while simultaneously moving the arms steadily into the first position one time; and
pointing the feet in the second position and raising the hips vertically off the floor to form a substantially straight line from the shoulders to the pointed feet while supporting the body weight on the shoulders and feet, then lowering the hips to the floor and repeating three times for a total of four repetitions while simultaneously moving the arms near the sides of the body.

12. The method of training the human body to perform ballet movements of claim 11, further comprising a step of performing a second tempo adagio stretch protocol and then a step of performing a second demi-plié in écarté stretch protocol.

13. The method of training the human body to perform ballet movements of claim 12, the human body further having a pelvis; a torso having a stomach, a chest, and an upper body; and a head with a chin and a forehead; the method further comprising a step of performing a tempo allegretto stretch protocol comprising:
lying on the back on the floor such that the spine is straight and the legs are extended, feet pointed in the first position, the arms curved at each respective side with the palms of the hands facing inwardly toward the body;
flexing the left foot and lifting the left leg up to an angle of about 20 degrees with respect to the floor while maintaining the right leg straight and on the floor with the right foot pointed then pointing the left foot and lowering the left leg to the floor and repeating three times while simultaneously moving the left arm into the second position and the right arm into the first position one time;
flexing the left foot and moving the left leg out to the left side slightly at about a 45-degree angle with respect to the right leg that is straight and on the floor with the right foot pointed then pointing the left foot and returning the left leg next to the right leg and repeating three times while simultaneously moving the left arm into the first position and the right arm into the second position one time;
returning the arms to the floor at each respective side facing inwardly toward the body;
lying on the right side of the body on the floor such that the right arm is extended straight, the head resting on the right arm, the left hand resting on the floor in front of the torso to help keep balance, the left hip and left leg stacked on top of the right hip and right leg and the feet pointed in the first position;
bending the left leg slightly so that the left foot touches the inside of the right heel and the toes of the left foot are pointed while maintaining the right leg straight and on the floor with the right foot pointed in the first position;
returning the left leg next to the right leg and repeating three times;
moving the left foot up the right leg to a hollow of the right knee, with the left knee extended outwardly;
returning the left leg to full extension and repeating once;
lying on the back on the floor such that the spine is straight and the legs are extended, feet pointed in the first position, the arms curved at each respective side with the palms of the hands facing inwardly toward the body;
flexing the right foot and lifting the right leg up to an angle of 20 degrees with respect to the floor while maintaining the left leg straight and on the floor with the left foot pointed then pointing the right foot and lowering the right leg to the floor and repeating three times while simultaneously moving the right arm into the second position and the left arm into the first position one time;
flexing the right foot and moving the right leg out to the right side slightly at about a 45-degree angle with respect to the left leg that is straight and on the floor with the left foot pointed then pointing the right foot and returning the right leg next to the left leg and repeating three times while simultaneously moving the right arm into the first position and the left arm into the second position one time;
returning the arms to the floor at each respective side facing inwardly toward the body;
lying on the left side of the body on the floor such that the left arm is extended straight, the head resting on the left arm, the right hand resting on the floor in front of the torso, the right hip and right leg stacked on top of the left hip and left leg and the feet pointed in the first position;
bending the right leg slightly so that the right foot touches the inside of the left heel and the toes of the right foot are pointed while maintaining the left leg straight and on the floor with the left foot pointed in the first position;
returning the right leg next to the left leg and repeating three times;
moving the right foot up the left leg to a hollow of the left knee, with the right knee extended outwardly;
returning the right leg to full extension and repeating once;
lying on the stomach on the floor with the legs extended straight back while pointing the feet, arms in front of the body bent inwardly, one hand stacked on the other and the forehead or chin resting on the hands;
flexing the left foot and lifting the left leg straight up to an angle of not more than 20 degrees with respect to the floor while maintaining the right leg straight and on the floor;
pointing the left foot and returning the left leg to the floor and repeating three times;
extending the left leg to the left side at a substantially 45-degree angle while the left foot is flexed and turned outwardly such that the inside of the left leg is pressing into the floor;
returning the left leg next to the right leg and repeating three times;
lying on the right side of the body on the floor such that the right arm is extended straight, the head resting on the right arm, the left hand resting on the floor in front of the torso to help keep balance, the left hip and left leg stacked on top of the right hip and right leg and the feet pointed in the first position;
bending the left leg slightly so that the left foot touches the inside of the right heel and the toes of the left foot are pointed while maintaining the right leg straight and on the floor with the right foot pointed in the first position;
returning the left leg next to the right leg and repeating three times;
moving the left foot up the right leg to the hollow of the right knee, with the left knee extended outwardly;
returning the left leg to full extension and repeating once;
lying on the stomach on the floor with the legs extended straight back while pointing the feet, arms in front of the body bent inwardly, one hand stacked on the other and the forehead or chin resting on the hands;
flexing the right foot and lifting the right leg straight up to an angle of not more than 20 degrees with respect to the floor while maintaining the left leg straight and on the floor;
pointing the right foot and returning the right leg to the floor and repeating three times;
extending the right leg to the right side at a substantially 45-degree angle while the right foot is flexed and turned outwardly such that the inside of the right leg is pressing into the floor; and
returning the right leg next to the left leg and repeating three times;
lying on the left side of the body on the floor such that the left arm is extended straight, the head resting on the left arm, the right hand resting on the floor in front of the torso, the right hip and right leg stacked on top of the left hip and left leg and the feet pointed in the first position;
bending the right leg slightly so that the right foot touches the inside of the left heel and the toes of the right foot are pointed while maintaining the left leg straight and on the floor with the left foot pointed in the first position;
returning the right leg next to the left leg and repeating three times;
moving the right foot up the left leg to the hollow of the left knee, with the right knee extended outwardly; and
returning the right leg to full extension and repeating once.

14. The method of training the human body to perform ballet movements of claim 13, further comprising a step of performing a tempo allegretto stretch protocol comprising
lying on the back on the floor such that the spine is straight and the legs are extended, feet pointed in the first position, the arms curved at each respective side with the palms of the hands facing inwardly towards the body;
flexing and lifting the left foot up to an angle of not more than 5 degrees with respect to the floor such that the left heel is above the right ankle and the left knee is bent outwardly then pointing the left foot and straightening the left leg at the same angle with the right foot pointed and forward at full extension and returning the left knee back to the bent position with the left foot flexed and resting above the right ankle and repeating three times while simultaneously moving the right arm into the second position one time;
bending the right leg into the demi-plié position and raising the hips off the floor such that the body weight is supported in the tops of the shoulders and the right foot;
extending the left leg out to the left side and pointing the left foot then flexing the left foot and bending the left leg in such that the left heel is resting above the right ankle and repeating three times while simultaneously moving the right arm into the first position one time;
lowering the hips to the floor, returning the left leg next to the right leg and pointing the left foot;
flexing and lifting the right foot up to an angle of not more than 5 degrees with respect to the floor such that the right heel is above the left ankle and the right knee is bent outwardly and pointing the right foot and straightening the right leg at the same angle with the left foot pointed and forward at full extension then returning the right knee back to the bent position with the right foot flexed and resting above the left ankle and repeating three times while simultaneously moving the left arm into the second position one time;
bending the left leg into the demi-plié position and raising the hips off the floor such that the body weight is supported in the tops of the shoulders and the left foot;
extending the right leg out to the right side and pointing the right foot then flexing the right foot and bending the right leg in such that the right heel is resting above the left ankle and repeating three times while simultaneously moving the right arm into the first position one time;
lowering the hips to the floor, returning the right leg next to the left leg, pointing the right foot and returning the arms to the floor at each respective side facing inwardly toward the body;
lying on the stomach on the floor with the legs extended straight back while pointing the feet, arms in front of the body bent inward, one hand stacked on the other and the forehead resting on the hands;
placing the hands on the floor under the shoulders with the fingers facing outwardly;
raising the body off the floor such that the body weight is supported on the hands and the tops of the feet such that the feet to the shoulders form a substantially straight line;
flexing the left foot and placing the inside of the left ankle above the bottom of the right heel such that the left knee is slightly bent and facing outwardly;
extending the left leg straight and behind the body, the left knee facing the floor, while pointing the left foot;
flexing and returning the left foot above the bottom of the right heel and repeating three times;
extending the left leg straight to the left side while pointing the left foot;
flexing and returning the left foot above the bottom of the right heel and repeating three times;
extending the left leg straight while pointing and lowering the left foot to the floor next to the right leg;
flexing the right foot and placing the inside of the right ankle above the bottom of the left heel such that the right knee is slightly bent and facing outwardly;
extending the right leg straight and behind the body, the right knee facing the floor, while pointing the right foot;
flexing and returning the right foot above the bottom of the left heel and repeating three times;
extending the right leg straight to the right side while pointing the right foot;
flexing and returning the right foot above the bottom of the left heel and repeating three times; and
extending the right leg straight while pointing and lowering the right foot to the floor next to the left foot.

15. The method of training the human body to perform ballet movements of claim 14, further comprising a step of performing a tempo valse stretch protocol comprising
performing a first sequence comprised of lying on the back on the floor such that the spine is straight and the legs are extended, feet pointed in the first position, the arms curved at each respective side with the palms of the hands facing inwardly toward the body; lifting the arms into the first position; lowering the arms into the second position; bending the right leg into a grand plié position with the right knee facing outwardly, resting on the floor while flexing the left foot, raising it vertically to no more than about 90 degrees with respect to the torso and moving the right arm into the first position;
lowering the left leg to the left side until it is no less than about 5 degrees off the floor while lowering the right arm into the second position; raising the left leg vertically until it is no more than about 90 degrees with respect to the torso while lifting the right arm into the first position; lowering the left leg forward of the body to the floor while lowering the right arm into a relaxed position at the right side of the body; and repeating the first sequence three times;
performing a second sequence comprised of lying on the back on the floor such that the spine is straight and the legs are extended, feet pointed in the first position, the arms curved at each respective side with the palms of the hands facing inwardly toward the body;
lifting the arms into the first position; lowering the arms into the second position; bending the left leg into the grand plié position with the left knee facing en dehors, resting on the floor while flexing the right foot, raising it vertically to no more than about 90 degrees with respect to the torso and moving the left arm into the first position;
lowering the right leg to the right side until it is no less than about 5 degrees off the floor while lowering the left arm into the second position;
raising the right leg vertically until it is no more than about 90 degrees with respect to the torso while lifting the left arm into the first position; lowering the right leg forward of the body to the floor while lowering the left arm into a relaxed position at the left side of the body; repeating the second sequence three times;
performing a third sequence comprised of lying on the stomach on the floor with the legs extended straight back while pointing the feet, hands on the floor next to the shoulders and facing outwardly and the forehead facing forward; raising the left leg and extending it to the left side, then lowering it to the floor such that the legs are spread wide apart;
raising the body off the floor such that the body weight is supported on the hands and the tops of the feet, and the feet to the shoulders form a substantially straight line; lowering the body to the floor;
lifting the left leg and lowering it next to the right leg; lifting the torso slowly until the arms are extended straight; lowering the torso slowly; repeating the third sequence with the left leg one time;
performing a fourth sequence comprised of raising the right leg and extending it to the right side, then lowering it to the floor such that the legs are spread wide apart; raising the body off the floor such that the body weight is supported on the hands and the tops of the feet, and the feet to the shoulders form a substantially straight line;
lowering the body to the floor; lifting the right leg and lowering it next to the left leg; lifting the torso slowly until the arms are extended straight; lowering the torso slowly; and
repeating the fourth sequence with the right leg one time.

16. The method of training the human body to perform ballet movements of claim 15, further comprising a step of performing a tempo sostendendo stretch protocol comprising
sitting on the floor such that the spine is straight and the legs are extended forward and spread wide apart from one another, the feet are pointed, the arms are straight next to the hips at each respective side, only the fingers of each hand touching the floor;
lifting the hips vertically off the floor so that the weight is supported evenly on the fingers and thumb and the heels of the feet, lowering the hips to the floor slowly;
raising the arms into a fifth position;
lowering the arms through the first position to the floor in front of the body;
placing the palms flat on the floor, one stacked on the other, in front of the body;
lifting the hips vertically off the floor while shifting the torso forward and keeping the spine straight;
lowering the hips to the floor slowly;
raising the arms to the fifth position;
lowering the arms to the second position;
repeating once;
lowering the left arm into the first position and the right arm into the fifth position;
bending the torso sideways from the hip towards the left knee, keeping the right hip firmly on the floor while maintaining a straight spine while extending the right arm straight and parallel to the left leg;
raising the torso so that the spine is extended straight and vertical;
repeating one time;
lowering the right arm into the first position and the left arm into the fifth position;
bending the torso sideways from the hip towards the right knee, keeping the left hip firmly on the floor while maintaining a straight spine while extending the left arm straight and parallel to the right leg;
raising the torso so that the spine is extended straight and vertical; and
repeating one time.

17. The method of training the human body to perform ballet movements of claim 16, further comprising a step of performing a tempo adagio stretch protocol comprising
lying on the back on the floor such that the spine is straight and the legs are extended, feet pointed in the first position, the arms curved at each respective side with the palms of the hands facing inwardly towards the body;
bending the left leg until the left foot is angled at the hollow of the right knee and the left knee angled at about 45 degrees from the right leg and the right foot pointed while raising the right arm into the first position;
extending the left leg straight and raising the left leg vertically until it is disposed from about 60 degrees to about 90 degrees with respect to the torso while lowering the right arm into the second position;
lowering and bending the left leg until the left foot is angled at the hollow of the right knee and the left knee angled at about 45 degrees from the right leg and the right foot pointed while raising the right arm into the first position;
extending the left leg straight and parallel to the right leg and returning the right arm to a relaxed position next to the right side;
repeating one time;
lying on the right side of the body on the floor such that the right arm is extended straight above, the head resting on the right arm, the left hand resting on the floor in front of the torso to help keep balance, the left hip and left leg stacked on top of the right hip and right leg and the feet pointed in the first position;
bending the left leg until the left foot is angled at the hollow of the right knee and the left knee angled at about 45 degrees from the right leg and the right foot pointed;
extending the left leg straight and raising the left leg vertically until it is disposed from about 60 degrees to about 90 degrees with respect to the torso;
lowering and bending the left leg until the left foot is angled at the hollow of the right knee and the left knee angled at about 45 degrees from the right leg, which remains extended and the right foot pointed;
extending the left leg straight and parallel to the right leg;
repeating one time;
lying on the back on the floor such that the spine is straight and the legs are extended, feet pointed in the first position, the arms curved at each respective side with the palms of the hands facing inwardly towards the body;
bending the right leg until the right foot is angled at the hollow of the left knee and the right knee angled at about 45 degrees from the left leg, which remains extended, and the left foot pointed while raising the left arm into the first position;
extending the right leg straight and raising the right leg vertically until it is disposed from about 60 degrees to about 90 degrees with respect to the torso while lowering the left arm into the second position;
lowering and bending the right leg until the right foot is angled at the hollow of the left knee and the right knee angled at about 45 degrees from the left leg, which remains extended and the left foot pointed while raising the right arm into the first position;
extending the right leg straight and parallel to the left leg and returning the left arm to a relaxed position next to the left side;
repeating one time;
lying on the left side of the body on the floor such that the left arm is extended straight above, the head resting on the left arm, the right hand resting on the floor in front of the torso to help keep balance, the right hip and right leg stacked on top of the left hip and left leg and the feet pointed in the first position;
bending the right leg until the right foot is angled at the hollow of the left knee and the right knee angled at about 45 degrees from the left leg, which remains extended and the left foot pointed;
extending the right leg straight and raising the right leg vertically until it is disposed from about 60 degrees to about 90 degrees with respect to the torso;
lowering and bending the right leg until the right foot is angled at the hollow of the left knee and the right knee angled at about 45 degrees from the left leg, which remains extended and the left foot pointed;
extending the right leg straight and parallel to the left leg;
repeating one time;
lying on the back on the floor such that the spine is straight and the legs are extended, feet pointed in the first position, the arms curved at each respective side with the palms of the hands facing inwardly towards the body;
bending both legs into a grand-plié position and raising the arms into the first position;
extending both legs vertically until they are about 60 degrees to about 90 degrees with respect to the torso and pointing the feet in the first position;
flexing the feet in the first position and lowering both legs to the floor simultaneously while lowering the arms into the second position;
repeating three times;
bending the legs into the grand plié position while raising the arms into the first position;
lifting the pelvis vertically off the floor such that the shoulders to the knees form a substantially straight line and the body weight is supported on the top of the shoulders and the exterior side of the feet and holding for at least one minute; and
lowering the pelvis to the floor and extending the legs straight, feet pointed in the first position, the arms curved at each respective side with the palms of the hands facing inwardly towards the body.

18. The method of training the human body to perform ballet movements of claim 17, further comprising a step of performing an allegretto stretch protocol comprising
lying on the back on the floor such that the spine is straight and the legs are extended, feet pointed in the first position, the arms curved at each respective side with the palms of the hands facing inwardly towards the body;
moving both arms into the first and then the second position;
flexing the left foot and lifting the left leg swiftly to an angle of no more than about 90 degrees with respect to the torso;
pointing the left foot and lowering the left leg slowly to the floor and repeating three times;
lying on the right side of the body on the floor such that the right arm is extended straight above, the head resting on the right arm, the left hand resting on the floor in front of the torso to help keep balance, the left hip and left leg stacked on top of the right hip and right leg and the feet pointed in the first position;
flexing the left foot and lifting the left leg swiftly to an angle of no more than about 90 degrees with respect to the torso;
pointing the left foot and lowering the left leg slowly to the floor;
repeating three times;
lying on the stomach on the floor such that the legs are extended straight back, the toes are pointed and the arms are crossed in front of the body with the head resting on the arms;
flexing the left foot and lifting the left leg quickly, maintaining full extension of the leg;
pointing the left foot and lowering the left leg slowly;
repeating three times;
lying on the right side of the body on the floor such that the right arm is extended straight above, the head resting on the right arm, the left hand resting on the floor in front of the torso to help keep balance, the left hip and left leg stacked on top of the right hip and right leg and the feet pointed in the first position;
flexing the left foot and lifting the left leg swiftly to an angle of no more than about 90 degrees with respect to the torso;
pointing the left foot and lowering the left leg slowly to the floor;
repeating three times;
lying on the back on the floor such that the spine is straight and the legs are extended, feet pointed in the first position, the arms curved at each respective side with the palms of the hands facing inwardly towards the body;
moving both arms into the first and then the second position flexing the right foot and lifting the right leg swiftly to an angle of no more than about 90 degrees with respect to the torso;
pointing the right foot and lowering the right leg slowly to the floor and repeating three times;
lying on the left side of the body on the floor such that the left arm is extended straight above, the head resting on the left arm, the right hand resting on the floor in front of the torso to help keep balance, the right hip and right leg stacked on top of the left hip and left leg and the feet pointed in the first position;
flexing the right foot and lifting the right leg swiftly to an angle of no more than about 90 degrees with respect to the torso;
pointing the right foot and lowering the right leg slowly to the floor;
repeating three times;
lying on the stomach on the floor such that the legs are extended straight back, the toes are pointed and the arms are crossed in front of the body with the head resting on the arms;
flexing the right foot and lifting the right leg quickly, maintaining full extension of the leg;
pointing the right foot and lowering the right leg slowly;
repeating three times;
lying on the left side of the body on the floor such that the left arm is extended straight above, the head resting on the left arm, the right hand resting on the floor in front of the torso to help keep balance, the right hip and right leg stacked on top of the left hip and left leg and the feet pointed in the first position;
flexing the right foot and lifting the right leg swiftly to an angle of no more than about 90 degrees with respect to the torso;
pointing the right foot and lowering the right leg slowly to the floor;
repeating three times;
sitting on the floor such that the spine is straight, the legs are bent, the feet are pointed, the bottoms of the feet are facing inward and the toes are touching;
grasping the bottom of the left heel with the left hand and the bottom of the right heel with the right hand such that the arms are extended straight and the inside of each elbow is facing out;
lifting the left leg so that it is extended straight at about a 45-degree angle with respect to the torso while keeping the spine straight;
holding this position for at least six seconds;
bending the left leg in at the knee until the toes are touching the floor;
lifting the right leg so that it is extended straight at about a 45-degree angle with respect to the torso while keeping the spine straight;
holding this position for at least six seconds;
bending the right leg in at the knee until the toes are touching the floor;
lifting both legs simultaneously such that the legs are extended straight and spread wide apart from one another, keeping the spine straight;
holding this position for at least six seconds; and
bending and lowering the legs slowly to the floor and releasing the hands from the back of the heels.
